(19) United States
(12) Patent Application Publication
(10) Pub. No.: US 2026/0316962 A1
(43) Pub. Date: Oct. 15, 2026

(54) UNPRESSURIZED SPACE DOCKING SYSTEM

(71) Applicant: Blue Origin Manufacturing, LLC, Huntsville, AL (US)

(72) Inventors: John Robert Christensen, Harvest, AL (US); Justin Chester Christenson, Mukilteo, WA (US); Trent Clinton Taylor, Huntsville, AL (US)

(21) Appl. No.: 19/646,445

(22) Filed: Apr. 13, 2026

Related U.S. Application Data
(60) Provisional application No. 63/787,647, filed on Apr. 11, 2025.

(51) Int. Cl. B64G 1/64; B65H 75/42; B65H 75/44; B65H 75/48

(52) U.S. Cl. CPC B64G 1/6464; B65H 75/425; B65H 75/4471; B65H 75/486

(57) ABSTRACT

The disclosure provides an unpressurized docking system that uses a soft capture system with a probe and drogue system. The probe, positioned on the chaser vehicle, couples the probe with the drogue, positioned on the target vehicle, to complete capture of the two spacecraft at contact.

### STATEMENT REGARDING U.S. GOVERNMENT SUPPORT

This invention was made with government support under Contract No. 80MSFC23CA014 awarded by NASA. The government has certain rights in this invention.

### INCORPORATION BY REFERENCE TO PRIORITYAPPLICATION

This application claims the benefit of U.S. Provisional Application No. 63/787647 filed Apr. 11, 2025, titled UNPRESSURIZED SPACE DOCKING SYSTEM, the entire content of which is incorporated by reference herein and forms a part of this specification for all purposes.

### BACKGROUND

### Field

The present disclosure relates generally to spacecraft docking systems, in particular to unpressurized spacecraft docking systems.

### Description of Related Art

Docking systems can be pressurized or unpressurized. Docking systems can derive their geometry and overall form from the International Docking System Standard (IDSS), maintained and published by a committee of worldwide space agencies, including NASA. IDSS is primarily directed to a pressurized system oriented toward crew transfer between docked vehicles, and in some cases can have commodity connectors added. Unpressurized docking, on the other hand, does not involve crew transfer and is directed to some type of space logistic activity, either commodity transfer (power, data, propellant) or takeover of a vehicle’s propulsion by a servicing vehicle as transferred through the mechanical docking interface. Additionally, docking operations may be achieved through physical contact due to relative motion of one vehicle against another (e.g., collision) or berth, where a visiting spacecraft enters the vicinity of a target spacecraft and maintains a holding pattern. In which case, a station arm or similar manipulator device grasps the visiting spacecraft and brings the visiting spacecraft into position near the target spacecraft. A capture device, usually located on the active system, latches onto the target and the mating continues until the final structural connection is achieved.

### SUMMARY OF EMBODIMENTS

The systems, methods, and devices of this disclosure each have several innovative aspects, no single one of which is solely responsible for all of the desirable attributes disclosed herein.

In some aspects, the techniques described herein relate to a soft capture docking system for a target spacecraft vehicle, the soft capture docking system including: a probe assembly configured to couple with a drogue assembly of a chaser spacecraft vehicle; a plurality of struts coupled to the probe assembly and the target spacecraft vehicle, the plurality of struts configured to attenuate motion between the target spacecraft vehicle and the chaser spacecraft vehicle; and a cable retract mechanism including a cable coupled to the probe assembly, wherein the cable retract mechanism is configured to retract the probe assembly, wherein the cable retract mechanism is configured to create a deadband zone such that there is constant tension on the cable during attenuation.

In some aspects, the techniques described herein relate to a soft capture docking system, the cable retract mechanism further including: a housing including: an arbor, a spool coupled to the arbor, the spool including a cable slot and at least one spiral groove including a first spiral groove extending between a first end at a center portion of the spool and a second end at an outer portion of the spool, wherein at least a portion of the cable is positioned within the cable slot, a slotted shaft including at least a first groove; an actuator coupled to the slotted shaft and configured to rotate the slotted shaft; and at least a first bearing positioned between the first spiral groove and the first groove, wherein the first bearing is configured to move within the first spiral groove and the first groove.

In some aspects, the techniques described herein relate to a soft capture docking system, wherein the first groove of the slotted shaft extends radially outward from an inner portion of the slotted shaft to an outer portion of the slotted shaft.

In some aspects, the techniques described herein relate to a soft capture docking system, wherein the cable is coupled to a yoke, wherein the yoke is coupled to the probe assembly, wherein the cable retract mechanism is configured to retract the yoke and the cable within the housing of the cable retract mechanism.

In some aspects, the techniques described herein relate to a soft capture docking system, wherein the cable slot includes a continuous groove configured to accommodate a length of the cable when the cable is fully retracted, such that revolutions of the cable within the cable slot are positioned adjacently within the continuous groove.

In some aspects, the techniques described herein relate to a soft capture docking system, wherein the cable slot is configured such that revolutions of the cable within the cable slot overlap vertically within the cable slot.

In some aspects, the techniques described herein relate to a soft capture docking system further including at least one spring configured to apply a constant tension force on the arbor to retract the cable.

In some aspects, the techniques described herein relate to a soft capture docking system, wherein the spool is configured to rotate relative to the slotted shaft when the first bearing is positioned between the first end and the second end of the first spiral groove.

In some aspects, the techniques described herein relate to a soft capture docking system, wherein rotation of the slotted shaft does not rotate the spool when the first bearing is positioned between the first end and the second end of the first spiral groove.

In some aspects, the techniques described herein relate to a soft capture docking system, wherein, when the first bearing is positioned at the first end or the second end of the first spiral groove, rotation of the slotted shaft rotates the spool.

In some aspects, the techniques described herein relate to a soft capture docking system further including a second spiral groove and a third spiral groove, wherein each of the first spiral groove, the second spiral groove, and the third spiral groove are the same length and non-overlapping.

In some aspects, the techniques described herein relate to a soft capture docking system further including a second bearing positioned within the second spiral groove and a third bearing positioned within the third spiral groove, wherein the slotted shaft includes a second groove configured to interface with the second bearing, and a third groove configured to interface with the third bearing.

In some aspects, the techniques described herein relate to a soft capture docking system, wherein the first bearing, the second bearing, and the third bearing are configured such that each bearing is in the same relative position within their corresponding spiral groove during rotation of the spool.

In some aspects, the techniques described herein relate to a cable retract mechanism for a spacecraft vehicle, the cable retract mechanism including: a housing including: an arbor, a spool coupled to the arbor, the spool including a cable slot and at least one spiral groove including a first spiral groove extending between a first end at a center portion of the spool and a second end at an outer portion of the spool, wherein at least a portion of a cable is positioned within the cable slot, a slotted shaft including at least a first groove; an actuator coupled to the slotted shaft and configured to rotate the slotted shaft; at least a first bearing positioned between the first spiral groove and the first groove, wherein the first bearing is configured to move within the first spiral groove and the first groove; and a yoke coupled to the cable, wherein the yoke is configured to be coupled to a probe assembly of the spacecraft vehicle.

In some aspects, the techniques described herein relate to a cable retract mechanism, wherein the first groove of the slotted shaft extends radially outward from an inner portion of the slotted shaft to an outer portion of the slotted shaft.

In some aspects, the techniques described herein relate to a cable retract mechanism, wherein the cable is coupled to a yoke, wherein the yoke is coupled to the probe assembly, wherein the cable retract mechanism is configured to retract the yoke and cable within the housing of the cable retract mechanism.

In some aspects, the techniques described herein relate to a cable retract mechanism, wherein the cable slot includes a continuous groove configured to accommodate a length of the cable when the cable is fully retracted, such that revolutions of the cable within the cable slot are positioned adjacently within the continuous groove.

In some aspects, the techniques described herein relate to a cable retract mechanism, wherein the cable slot is configured such that revolutions of the cable within the cable slot overlap vertically within the cable slot.

In some aspects, the techniques described herein relate to a cable retract mechanism further including at least one spring configured to apply a constant tension force on the arbor to retract the cable.

In some aspects, the techniques described herein relate to a cable retract mechanism, wherein the spool is configured to rotate relative to the slotted shaft when the first bearing is positioned between the first end and the second end of the first spiral groove.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, may be arranged, substituted, combined, and designed in a wide variety of different configurations, all of which are explicitly contemplated and make part of this disclosure.

FIG. 1 illustrates a schematic representation of a chaser vehicle and a target vehicle incorporating an embodiment of an unpressurized docking system of the present disclosure.

FIG. 2A illustrates a schematic representation of a soft capture stage of an unpressurized docking process.

FIG. 2B illustrates a schematic representation of an attenuation stage of an unpressurized docking process.

FIG. 2C illustrates a schematic representation of a retraction stage of an unpressurized docking process after full retraction between the chaser vehicle and target vehicle.

FIG. 3A illustrates an embodiment of chaser vehicle soft capture components and target vehicle soft capture components prior to soft capture.

FIG. 3B illustrates an embodiment of chaser vehicle soft capture components and target vehicle soft capture components after completion of soft capture and retraction processes.

FIG. 4 illustrates an embodiment of a drogue assembly.

FIG. 5 illustrates an example embodiment of a coupling between the probe and the drogue after the soft capture stage of the unpressurized docking process.

FIG. 6A illustrates an embodiment of soft capture system components on the chaser vehicle.

FIG. 6B illustrates a top view of the embodiment of the soft capture system components of the chaser vehicle in the deployed position.

FIG. 6C illustrates a side view of the embodiment of the soft capture system components of the chaser vehicle in the retracted position.

FIG. 7 illustrates an embodiment of the probe assembly of the soft capture system.

FIG. 8 illustrates a cross-section view of the embodiment of the probe assembly of FIG. 7.

FIG. 9A illustrates an embodiment of a cross-section of the probe that includes a latching assembly of the probe.

FIG. 9B illustrates an embodiment of the latching assembly broken out from the probe.

FIG. 9C illustrates a cross-section of the embodiment of the latching assembly broken out from the probe with the latch in a disengaged configuration.

FIG. 9D illustrates a cross-section of the embodiment of the latching assembly broken out from the probe with the latch in an engaged configuration.

FIG. 10A illustrates an example configuration of the probe and the drogue during the soft capture stage of the docking process with triggers armed and with latches in a disengaged configuration.

FIG. 10B illustrates an example configuration of the probe and the drogue during the soft capture stage of the docking process with the triggers activated and the latches deployed.

FIG. 11 illustrates an embodiment of a bearing assembly and probe housing of the soft capture system.

FIG. 12A illustrates an embodiment of a bearing lock assembly of the soft capture system.

FIG. 12B illustrates a cross-section view of the bearing lock assembly of FIG. 12A.

FIG. 13A illustrates components of the probe assembly with the bearing lock assembly in an open position.

FIG. 13B illustrates components of the probe assembly with the bearing lock assembly in a closed position.

FIG. 14A illustrates a cross-section view of an embodiment of a probe leg assembly of the soft capture system.

FIG. 14B illustrates a cross-section view of another embodiment of a probe leg assembly of the soft capture system.

FIG. 15 illustrates a schematic illustration of degrees of freedom of the soft capture system.

FIG. 16 illustrates an embodiment of the cable retract mechanism assembly of the soft capture system.

FIG. 17 illustrates a cross-section view of the cable retract mechanism of FIG. 16.

FIG. 18A illustrates a partial exploded view of the cable retract mechanism.

FIG. 18B illustrates an example embodiment of a spool of the cable retract mechanism.

FIG. 18C illustrates an example embodiment of a slotted shaft of the cable retract mechanism.

FIG. 19 illustrates another embodiment of the probe assembly of the soft capture system.

FIG. 20 illustrates an exploded view of bearing assembly.

FIG. 21 illustrates an embodiment of a roll control gear train assembly.

FIG. 22 illustrates another embodiment of the cable retract mechanism subassembly of the soft capture system.

FIG. 23 illustrates a cross-section view of the cable retract mechanism of FIG. 22.

FIG. 24 illustrates a partial exploded view of the cable retract mechanism of FIG. 21.

FIG. 25 illustrates a schematic representation of an attenuation envelope of the soft capture system.

FIG. 26 illustrates a schematic representation of a retraction envelope of the soft capture system.

### DETAILED DESCRIPTION

The following detailed description is directed to certain specific embodiments for devices, systems, and methods related to unpressurized docking systems. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the disclosure. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments. Reference will now be made in detail to embodiments of the disclosure, examples of which are illustrated in the accompanying drawings. Wherever possible, the same reference numbers will be used throughout the drawings to refer to the same or like parts.

The embodiments disclosed herein each have several aspects, no single one of which is solely responsible for the disclosure’s desirable attributes. Without limiting the scope of this disclosure, its more prominent features will now be briefly discussed. The features of the embodiments described herein provide advantages over existing systems, devices, and methods for unpressurized spacecraft docking systems.

The following disclosure describes non-limiting examples of some embodiments. For instance, other embodiments of the disclosed systems and methods may or may not include the features described herein. Moreover, disclosed advantages and benefits may apply only to certain embodiments of the disclosure and should not be used to limit the disclosure.

### Overview

Large-scale operations in space require refueling of large vehicles and propulsive maneuvering of mated vehicle pairs in various Earth and interplanetary orbits. The unpressurized docking system enables controlled, gentle soft capture and attenuation between two vehicles to enable subsequent hard-capture and refueling operations. The docking system can additionally enable a lunar transporter or other similar vehicle to perform orbital maneuvering propulsion for a docked vehicle.

The unpressurized docking system includes soft capture and hard capture systems. The soft and hard capture systems contain active and passive components on the chaser spacecraft vehicle and the target spacecraft vehicle. During the docking process, the chaser vehicle can be actively navigated to couple with the target vehicle based on the initial contact specifications of the IDSS. When the two vehicles make initial contact, soft capture mechanisms latch the two vehicles together and attenuate relative motion between the two vehicles. After the motions are stabilized, an active cable retract mechanism can retract, thereby pulling the spacecraft together and aligning the hard capture system, which can actuate a set of assemblies to lock the two vehicles together.

The unpressurized docking system uses a soft capture system that is based on a passive probe and drogue system. The probe and drogue are sized to accommodate the initial contact conditions of the IDSS, which define approach velocity and alignment limits. The probe, positioned on the chaser vehicle, utilizes a set of capture latches that couple the probe with the drogue, positioned on the target vehicle, to complete capture of the two spacecraft at contact. The probe is a passive mechanism that provides compliance using various mechanisms, such as springs and bearings. Once the soft capture latches couple the probe with the drogue, the probe can lock out rotational movements, such as pitch and yaw. This allows the compliance to transfer to the probe legs beneath the probe. The probe legs can include spring(s) and damper(s) to allow attenuation of the system. The probe may further include a damper that can attenuate additional motion, such as roll. Once an attenuation threshold is achieved the probe is retracted with a centrally located cable retract mechanism.

The unpressurized docking system can use a hard capture system that includes a set of hard capture assemblies that lock the two spacecraft together structurally. Hard capture can be achieved when the active assemblies are engaged with corresponding passive assemblies.

Large masses colliding in zero-G can create large forces and moments, if not controlled via energy absorption technology. The soft capture system can provide energy absorption and efficient load management during soft capture. The soft capture system enables energy absorption and attenuation without the need for complex algorithms and feedback-controlled actuators. The footprint of the soft capture system enables load spreading to minimize concentrated loads at a single point on the target vehicle structure.

### Example Unpressurized Docking System

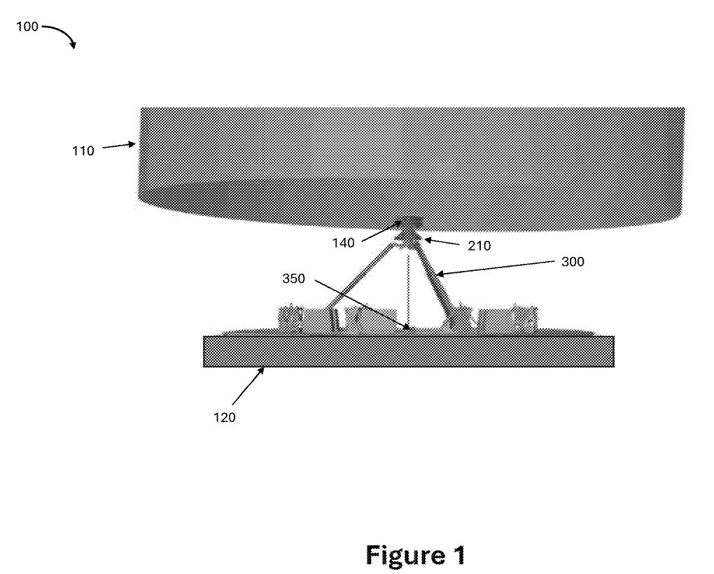

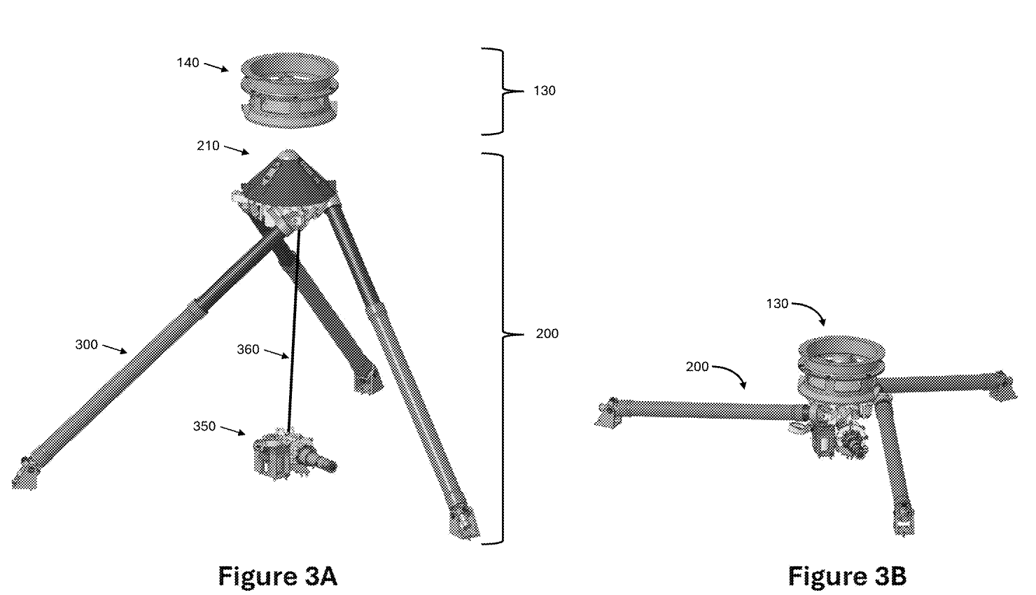

FIGS. 1, 3A, and 3A, illustrate an embodiment of an unpressurized docking system 100. The unpressurized docking system 100 is configured to control docking between a chaser spacecraft vehicle 120 and a target spacecraft vehicle 110. The chaser spacecraft vehicle 120 and the target spacecraft vehicle 110 each include soft capture system components. The target vehicle 110 soft capture components 130 include the drogue assembly 140. The chaser vehicle soft capture components 200 include the probe 210, the probe legs 300, and the cable retract mechanism 350.

### Docking Process

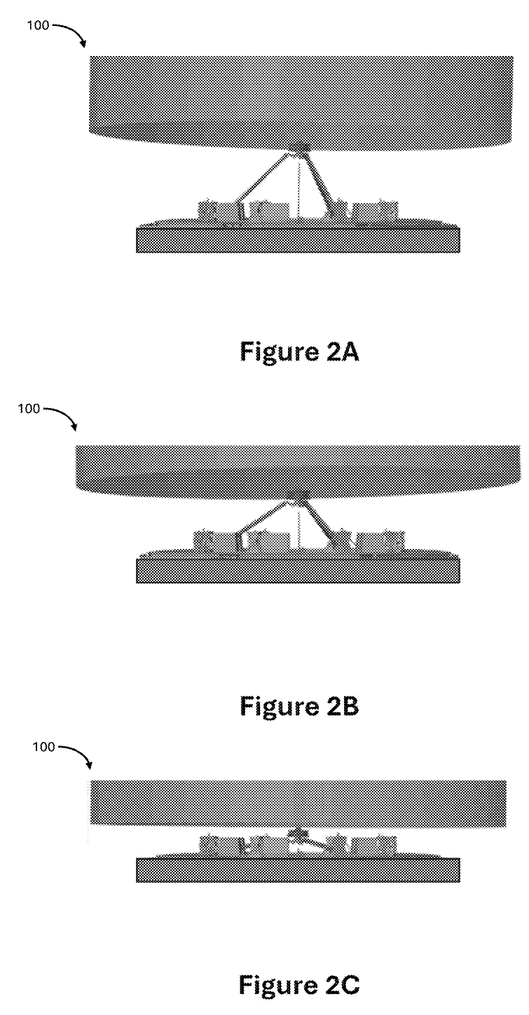

The unpressurized docking process is further illustrated and described with respect to FIGS. 2A–2C. The unpressurized docking system can integrate instrumentation and sensors to provide feedback and confirmation of critical docking events such as soft capture complete, ready to hard capture, dock complete, and undock complete. All system operation, status, and control can be performed through a dedicated system controller. These processes can be performed autonomously with no human operator in the loop.

During the unpressurized docking process, the target vehicle and chaser vehicle can go through the following stages:

### Preparation Stage

The target vehicle 110 can activate heaters, exercise actuators, and verify operation of sensors associated with the docking process. The target vehicle 110 can extend the probe 210 to the “ready to capture” (RTC) position. In FIG. 1, the chaser vehicle 120 and the target vehicle 110 have not yet initiated contact with the soft docking components and are in the preparation stage. The chaser vehicle 120 is positioning itself within space so that the probe 210 and drogue 150 soft capture mechanisms can interface with each other for the unpressurized docking process. After the target vehicle 110 finishes the preparation stage, the target vehicle 110 may communicate with the chaser vehicle 120 that it is in a “ready to dock” state.

### Soft Capture Stage

During the soft capture stage, the probe 210 and drogue 150 make first contact. The probe 210 deflects as required until it aligns with the drogue 150 on the target vehicle 110. Prior to first contact, the chaser vehicle 120 controls the positioning of the chaser vehicle 120 until it is in position in accordance with standards for unpressurized docking (e.g., IDSS standards). The drogue 150 and probe 210 are configured so that there are defined orientations to align the soft capture components. When the components are aligned and the probe 210 is fully seated within the drogue 150, soft capture latches 222 are triggered in the probe 210, and the probe 210 and drogue 150 are coupled together. Once the coupling is complete, a sensor signal can be transmitted and/or communicated to the target vehicle 110 and/or chaser vehicle 120 that the soft capture stage has been successfully completed. The drogue assembly 140 can include a sensor configured to indicate successful soft capture by detecting presence of the probe 210 in a latched position. FIG. 2A illustrates the soft capture stage after the drogue 150 and the probe 210 have been coupled together. After the soft capture stage, the docking process proceeds to the attenuation stage.

### Attenuation Stage

During the attenuation stage, the soft capture components of the target vehicle 110 are configured to attenuate relative movement between the chaser vehicle 120 and the target vehicle 110 until the chaser vehicle 120 attenuation threshold is satisfied. FIG. 2B illustrates the attenuation stage. The attenuation threshold is satisfied when movement of the vehicles is at or below an acceptable alignment of relative position, orientation, and rates based at least in part on sensor data that can output or infer pitch, yaw, and translation data associated with components of the soft capture system. This data can be measured and recorded by one or more sensors. The sensor data can then be transmitted to the controller for further processing and further control of the docking process.

The soft capture system can utilize passive components to attenuate movement of the vehicles. The struts can attenuate relative pitch, yaw, and translation between the chaser and target vehicles. The probe can include a bearing lock assembly 240 that, when engaged, can remove degrees of freedom from the probe. In some embodiments, the soft capture system can further engage a roll damper. The roll damper can attenuate roll of the chaser vehicle. After the attenuation threshold has been satisfied, the target vehicle and chaser vehicle can communicate to indicate that attenuation is complete.

### Retraction Stage

After the attenuation stage, the active stage of the soft capture process is initiated by retracting the chaser vehicle 120 to the target vehicle 110. Up until the retraction stage, the docking process can be a mechanically passive process. A cable 360 extends between the probe 210 and a cable retract mechanism 350. The cable retract mechanism 350 can retract at a controlled rate to bring the chaser vehicle 120 and the target vehicle 110 together. As the cable 360 retracts, the probe legs 300 can telescope inward and align hard capture components of the chaser vehicle 120 with hard capture components of the target vehicle 110. FIG. 2C illustrates a representation of the retraction stage when the chaser vehicle 120 is fully retracted to the target vehicle 110. When hard capture planes of corresponding hard capture components make contact, sensors can be triggered. A signal can be sent from the sensors to the target vehicle 110 and the chaser vehicle 120 to indicate that the docking process is ready for the hard capture stage.

### Hard Capture Stage

At the hard capture stage, the target vehicle can engage a hard capture process to interface with the chaser vehicle. During the hard capture stage, the hard capture components can be engaged. In some embodiments, hard capture components can engage either individually or simultaneously. The hard capture components can be locked into position such that the unpressurized docking system can be moved into a standby or power-down state.

### Undocking Process

During the undocking process, the target vehicle and chaser vehicle go through the following stages:

### Preparation Stage

During the preparation stage, all heaters are activated, and all sensors associated with the undocking process are verified. After the preparation stage is complete, a signal can be communicated to the target vehicle and/or chaser vehicle that the system is ready to release hard capture components.

### Hard Capture Release Stage

During the hard capture release stage, the target vehicle releases hard capture latches in a defined pattern, such as two latches at a time in a cross pattern. After the latches have been released, the target vehicle can communicate to the chaser vehicle that the hard capture latches have been released.

### Soft Capture Release Stage

During the soft capture release stage, the target vehicle 110 releases the soft capture latches 222, and the probe 210 and drogue 150 are decoupled. After the decoupling, the target vehicle 110 receives a signal that soft capture latches 222 have been released, and the signal can be communicated to the chaser vehicle 120. The chaser vehicle 120 can then fly the vehicles apart.

### Stow Stage

After the chaser vehicle 120 flies away, the probe 210 can be retracted from the capture position to the stowed position. Stowing the probe 210 can also cause the bearing lock assembly 240 to be reset. The unpressurized docking system on the chaser vehicle 120 can be powered down or set in standby mode.

### Soft Capture Components

FIG. 3A illustrates an embodiment of chaser vehicle soft capture components 200 and target vehicle soft capture components 130 prior to soft capture. FIG. 3B illustrates an embodiment of chaser vehicle soft capture components 200 and target vehicle soft capture components 130 after completion of soft capture and retraction processes. The target vehicle soft capture components 130 include the drogue assembly 140. The chaser vehicle soft capture components 200 include the probe 210, the probe legs 300, and the cable retract mechanism 350.

### Drogue Assembly

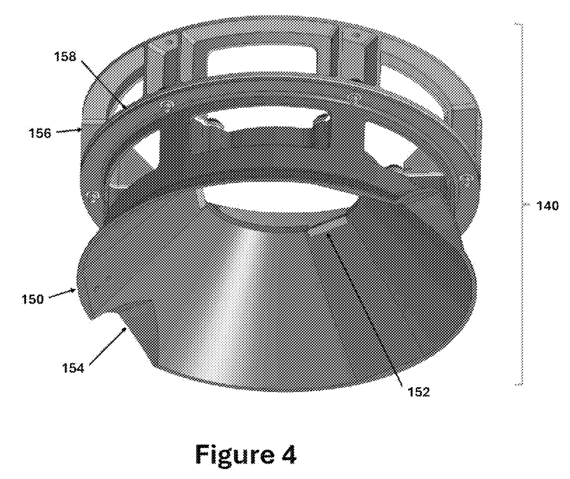

FIG. 4 illustrates an embodiment of the drogue assembly 140. The drogue assembly 140 includes a drogue adapter bracket 156, an electrostatic discharge (ESD) isolator 158, and a drogue 150. In some embodiments, the drogue assembly 140 is configured to be mounted to, and fixed relative to, the target spacecraft vehicle 110 and is configured to couple with a probe assembly 210 of a chaser spacecraft vehicle 120.

The drogue 150 and probe cover 220 can include mating features (also referred to herein as alignment features) to ensure proper alignment and to allow the soft capture latches 222 to couple together. For example, at least one alignment feature 216 on the probe assembly 210 can be configured to engage with at least one alignment feature 154 on the drogue assembly 140. In some embodiments, the probe assembly 210 is configured to move relative to the drogue assembly 140 until the alignment feature(s) 216 on the probe assembly 210 align with the alignment feature(s) 154 on the drogue assembly 140, wherein the probe assembly 210 is configured to move by rotating about at least one axis and/or translating in at least one direction relative to the drogue assembly 140. In the illustrated embodiment, the drogue 150 is configured with a pair of roll alignment slots 154 that align with a corresponding pair of alignment members 216 on the probe 210 such that the probe assembly 210 aligns with the drogue assembly 140 in a single defined orientation. The drogue 150 can include a plurality of striker plates 152 (e.g., three striker plates 152) that correspond to, and provide engagement features for, a plurality of sets of engagement components on the probe 210 (e.g., latch 222 and trigger 224 mechanisms). The drogue adapter bracket 156 can include offset mounting holes to prevent incorrect installation, which would result in an incorrect orientation of the drogue 150, on the target vehicle 110.

The drogue adapter bracket 156 and the drogue 150 can be separated by the ESD isolator 158 but bridged together via a jumper with an inline bleed resistor. This can prevent detrimental ESD between docking vehicles during first contact. The drogue 150 can include a sensor to detect when the probe 210 is fully seated within the drogue 150.

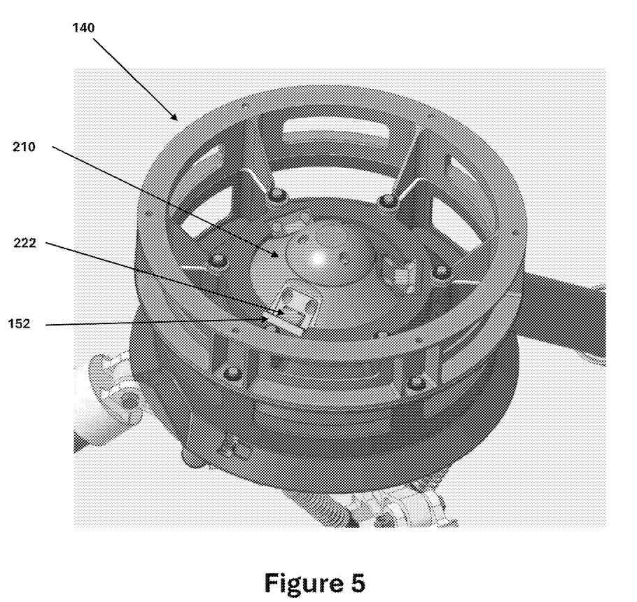

FIG. 5 illustrates the coupling of the probe 210 with the drogue 150 after the soft capture stage. As illustrated, the soft capture latches 222 on the probe 210 are engaged with corresponding engagement features (e.g., striker plates 152) on the drogue 150. In some embodiments, the probe assembly 210 includes a plurality of sets of engagement components, each set comprising a latch 222 and trigger mechanism 224. A latching synchronizer 228 can be coupled to each set of engagement components. The latching synchronizer 228 can be configured to prevent non-simultaneous engagement of each of the plurality of latches 222 with the engagement features of the drogue assembly 140 after the triggers 224 are actuated.

### Chaser Vehicle Soft Capture System Components

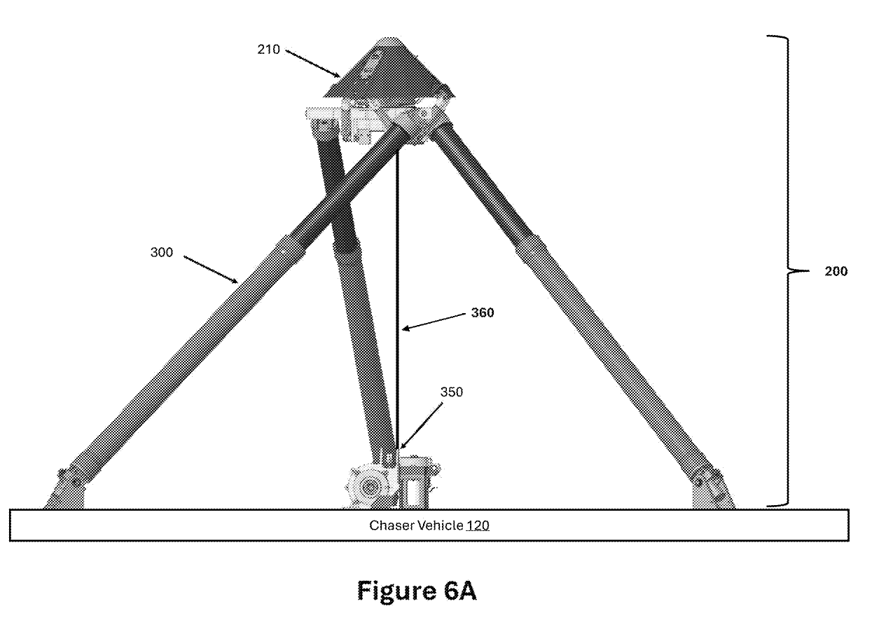

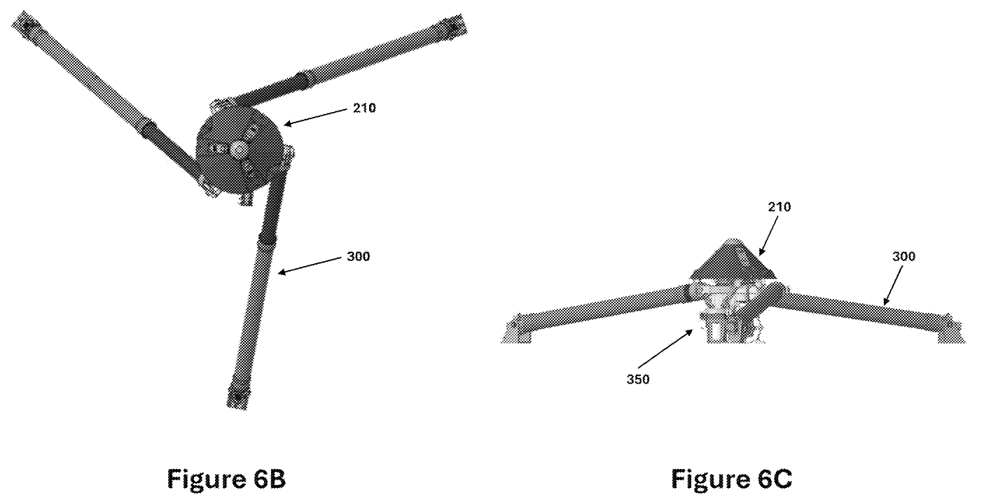

FIG. 6A illustrates soft capture system components that are installed on the chaser vehicle 120. FIG. 6B illustrates a top view of the embodiment of the soft capture system components of the chaser vehicle 120 in the deployed position. FIG. 6C illustrates a side view of the embodiment of the soft capture system components of the chaser vehicle 120 in the retracted position. The chaser vehicle 120 soft capture system components 200 include the probe assembly 210 (also referred to herein as probe 210), probe legs 300, and the cable retract mechanism 350.

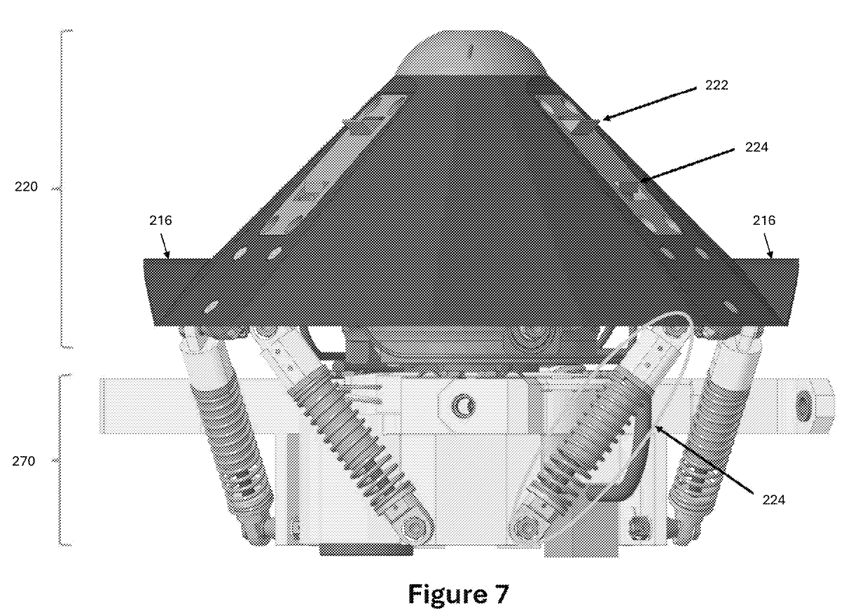

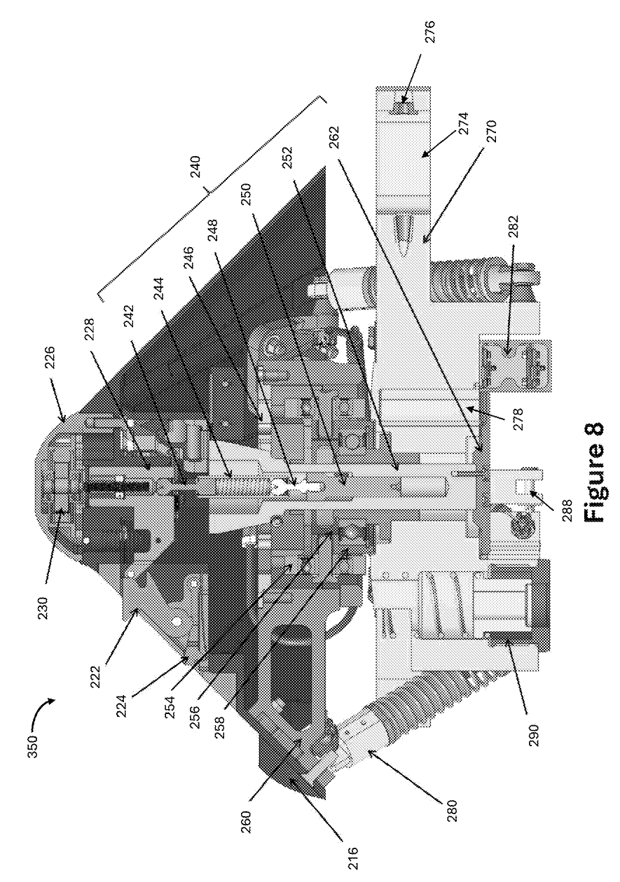

FIG. 7 illustrates an embodiment of the probe assembly 210 of the soft capture system. FIG. 8 illustrates a cross-section view of the embodiment of the probe assembly 210 of FIG. 7. The probe assembly 210 includes the probe cover 220, a probe base 260, a probe housing 270, a latching assembly, a bearing lock assembly 240, a bearing assembly 282, and a plurality of probe strut assemblies 280.

The probe cover 220 is coupled to the probe base 260. The probe base 260 is coupled to the bearing assembly 282 and the bearing lock assembly 240. The latching assembly 218 is positioned within and coupled to the probe cover 220. The probe housing 270 is coupled to the bearing lock assembly 240. The bearing assembly 282 is configured so that the probe cover 220 and probe base 260 can rotate relative to the probe housing 270. In some embodiments, the probe cover-probe housing interface is defined by (i) the bearing assembly 282, which provides relative rotational compliance between the probe cover 220 (and probe base 260) and the probe housing 270 when the bearing lock assembly 240 is in the open position, and (ii) the bearing lock assembly 240, which is configured to selectively constrain relative motion when the bearing lock assembly 240 transitions to the closed position. During soft capture and early attenuation, contact loads from the drogue 150 can be transferred into the probe cover 220 and then into the probe housing 270 through the bearing assembly 282 and the probe strut assemblies 280. The probe cover 220 can pivot relative to the probe housing 270 to accommodate misalignment while remaining mechanically coupled. During the transition from the open position to the closed position, the probe cover 220 can be biased toward a centered (null) orientation relative to the probe housing 270 by the probe strut assemblies 280 and by the bearing lock springs 264, thereby promoting engagement of the bearing lock plug 252 with the bearing lock socket 246 and rigidizing the probe cover 220 relative to the probe housing 270.

The probe housing 270 includes a central body and a plurality of housing arms 272 (e.g., three arms 272) that extend radially outward from a region proximate a center axis of the probe assembly 210 (probe 210). Each housing arm 272 includes a probe leg mounting interface 274 for mounting a corresponding probe leg 300. In some embodiments, the probe leg mounting interface 274 can be a joint interface configured to couple to a first end of the probe leg 300 such that axial loads, lateral loads, and moments transmitted through the probe legs 300 during attenuation and retraction. The housing arms 272 and probe leg mounting interfaces 274 are configured to couple with the probe legs 300 at an offset angle from a center axis of the probe assembly 210. The offset angle is less than 90 degrees, such as between 85 degrees and 55 degrees, between 60 degrees and 85 degrees, or another angle that is less than 90 degrees. In some embodiments, the offset angle and arm spacing are selected to provide a stable tripod geometry (e.g., to reduce susceptibility to lateral buckling and/or kinematic instability) while allowing the probe legs 300 to telescope during retraction without interference. The probe housing 270 further includes a yoke mounting interface 288 configured to engage a yoke 362 (connected to the cable 360) of the cable retract mechanism 350. In some embodiments, the yoke mounting interface 288 is positioned proximate the center axis of the probe assembly 210 such that tension in the cable 360 is transferred into the probe housing 270 along (or approximately along) the center axis, which can reduce off-axis loading of the probe assembly 210 during retraction. The probe housing 270 can provide a structural load path between the cable retract mechanism 350 (via the cable 360 and yoke 362) and the probe legs 300.

The probe housing 270 is configured to interface with the bearing lock assembly 240. The probe housing 270 includes a plurality of bearing lock spring cavities 278. The bearing lock spring cavities 278 can be configured to house the bearing lock springs 264 and are sized such that the bearing lock springs 264 are in compression and exert a force (e.g., an upward reaction force) on an upper wall of a respective bearing lock spring cavity 278 when the bearing lock assembly 240 is in the open position. In some embodiments, the probe housing 270 further provides one or more locating and/or guiding features (e.g., a bore, rail, shoulder, or bearing surface) that support and guide translation of one or more components of the bearing lock assembly 240 relative to the probe housing 270 during the transition from the open position to the closed position.

The bearing lock assembly 240 can be configured to translate relative to the probe housing 270 when the bearing lock assembly 240 moves from the open position to the closed position. In some embodiments, the probe housing 270 supports and guides such translation. For example, one or more bearing lock components (e.g., a bearing lock housing 266 and/or bearing lock base plate 262) can be received within, and guided by, a corresponding interface of the probe housing 270 such that the bearing lock assembly 240 translates generally along the center axis of the probe assembly 210. In the open position, the bearing lock assembly 240 can be restrained relative to the probe housing 270 by the bearing lock release rollers 268 and release cam 250 arrangement described herein. For example, the bearing lock release rollers 268 can constrain movement of the bearing lock base plate 262 relative to the probe housing 270 such that a bearing lock plug 252 remains spaced from a bearing lock socket 246 (e.g., defining a gap) while the probe cover 220 is permitted to rotate relative to the probe housing 270 via the bearing assembly 282.

When the bearing lock assembly 240 is released (e.g., when actuation of the release cam 250 disengages the bearing lock release rollers 268), the bearing lock springs 264, which are housed in the probe housing 270 spring cavities, apply a force to the bearing lock base plate 262. The bearing lock springs 264 can apply a downward force on the bearing lock base plate 262 (and a corresponding upward reaction force on the probe housing 270) such that the bearing lock base plate 262 translates relative to the probe housing 270. The bearing lock plug 252 can be coupled to the bearing lock base plate 262 such that translation of the bearing lock base plate 262 causes the bearing lock plug 252 to move toward and into the bearing lock socket 246. In some embodiments, the probe housing 270 provides a reference structure for the bearing lock socket 246 (e.g., via coupling to the bearing lock assembly 240) such that the probe housing 270 maintains alignment of the bearing lock socket 246 relative to the center axis while the bearing lock plug 252 is driven into the bearing lock socket 246. As described herein, the bearing lock plug 252 can seat within the bearing lock socket 246 over a period of time while the probe cover 220 continues to move (e.g., oscillate) relative to the probe housing 270. The probe strut assemblies 280 and bearing lock springs 264 can cooperate to bias the probe cover 220 toward a center (null) position, thereby promoting full seating. The bearing lock springs 264 and probe strut assemblies 280 can help to ensure that as the attenuating vehicles naturally drift through a centered position of the probe cover 220 relative to the probe housing 270, the bearing lock plug 252 seats itself further and prevents the bearing lock plug 252 from travelling further back out of alignment. In the closed position, the bearing lock assembly 240 is locked in position relative to the probe housing 270 such that the bearing lock plug 252 is seated within the bearing lock socket 246 and relative rotation between the probe cover 220 and the probe housing 270 is prevented.

### Probe Strut Assembly

The probe assembly 210 can include a plurality of probe strut assemblies 280. The probe strut assemblies 280 are coupled between the probe cover 220 (via the probe base 260) and the probe housing 270. For example, each probe strut assembly 280 can couple to the probe base 260 at a first attachment location and to the probe housing 270 at a second attachment location such that the plurality of probe strut assemblies 280 provide a plurality of spaced-apart load paths between the probe cover 220 and the probe housing 270. The probe strut assemblies 280 can provide a centering force between the probe cover 220 and the probe housing 270, which can be provided to all three axes of the bearing assembly 282. The probe struts can be spring-loaded in tension and compression, and arranged around the probe 210 in a similar fashion to the legs of a Stewart platform. The probe strut assemblies 210 can help to ensure the probe cover 220 and probe base 260 are at a controlled and centered orientation relative to probe housing 270 when the probe assembly 210 is in RTC position.

In some embodiments, the Stewart platform-like arrangement provides a plurality of spaced-apart load paths between the probe cover 220 and the probe housing 270 such that, during soft capture and attenuation, the probe struts can accommodate small relative deflections while biasing the probe cover 220 toward a centered (null) position relative to the probe housing 270. For example, differential compression and/or extension of the probe struts can provide restoring forces and moments that tend to reduce lateral offset and angular misalignment of the probe cover 220 relative to the probe housing 270. In some embodiments, such multi-point load sharing can distribute off-axis contact loads and/or moments across multiple probe struts, reduce peak loads at any one joint or attachment point, reduce concentrated side loads and binding on the bearing assembly 282 and associated components, and promote repeatable centering of the probe cover 220 prior to and during movement of the bearing lock assembly 240 toward the closed position. In some embodiments, the probe struts 280 can be connected at each end through slot-loaded spherical joints, with a coupling mechanism, such as a shear bolt. In the illustrated embodiment, there are six probe struts.

### Latching Assembly

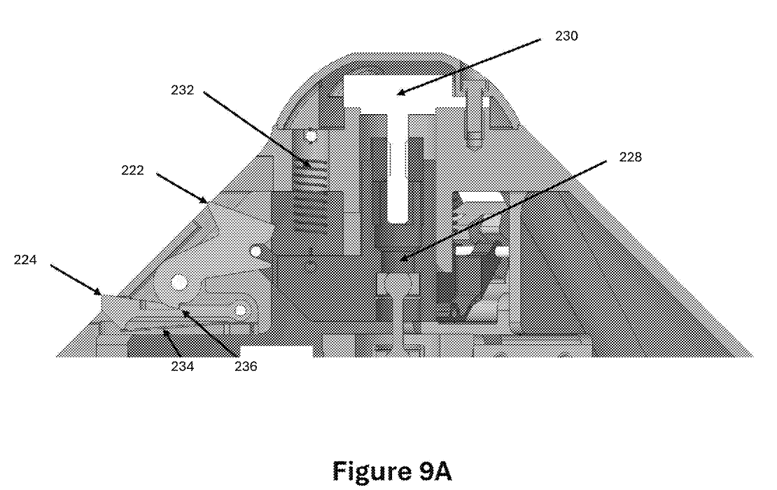

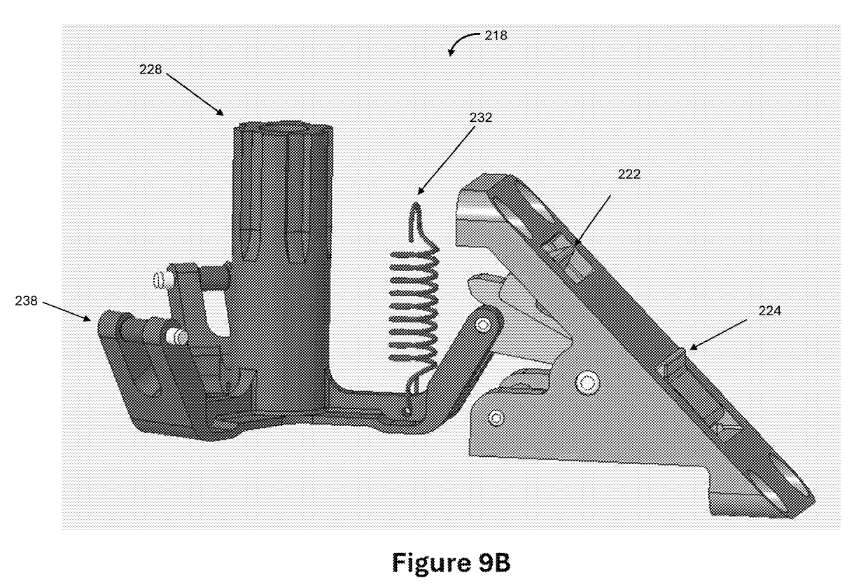

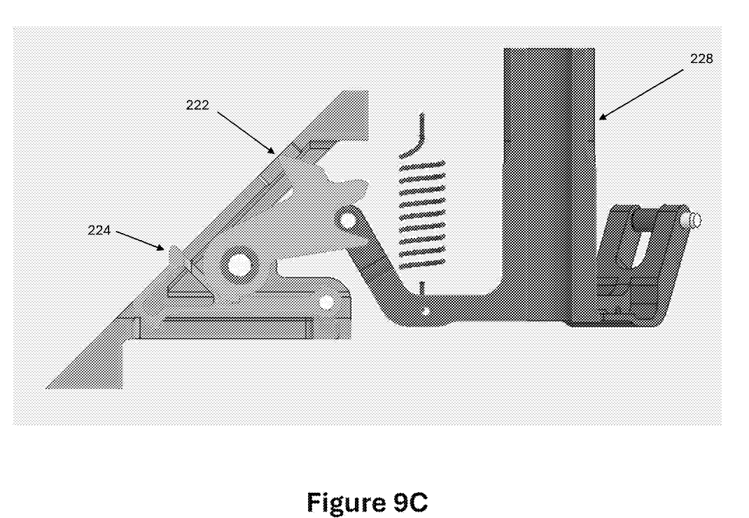

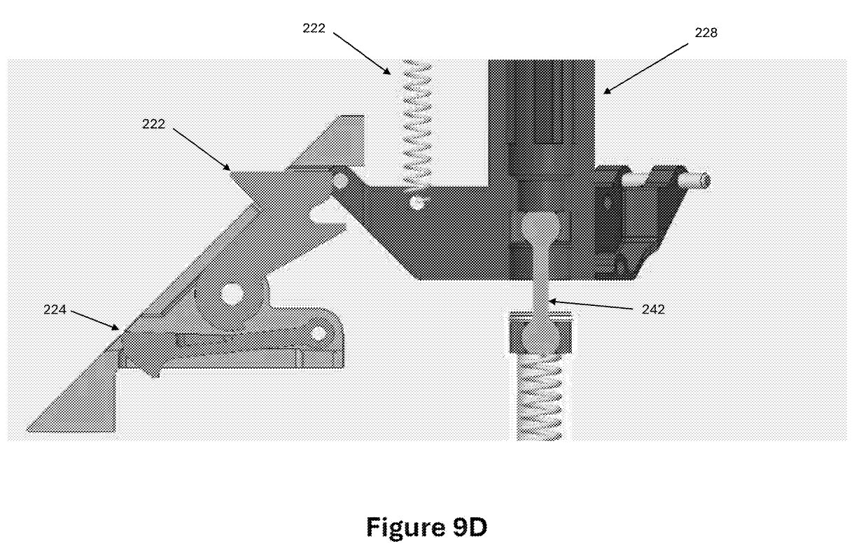

FIGS. 9A-9D illustrate components of the soft capture latching assembly 218. FIG. 9A is a cross-section of the probe 210 that highlights the latching assembly 218 among other components of the probe 210. FIG. 9B illustrates the latching assembly 218 broken out from the probe 210. FIG. 9C illustrates a cross-section of the latching assembly 218 broken out from the probe 210. FIG. 9D illustrates the latching assembly 218 in an engaged configuration in combination with selected components from the probe 210.

The latching assembly 218 can include a latching synchronizer 228, which has a plurality of arms 238, such as three arms 238, disposed symmetrically about a center column. One end of a spring 232 can be coupled to each arm 238 and coupled to an upper surface of the probe 210 on the other end. The spring 232 can be configured to provide an upward force on the latching synchronizer 228 to engage the latches 222. The latching assembly can include three sets of triggers 224 and latches 222. The latches 222 will engage after all of the triggers 224 are disengaged. When the trigger 224 is disengaged, the latch 222 can then rotate into the engaged position. The trigger 224 is engaged in an active position by a trigger spring 234 (such as illustrated in FIG. 9A). The latching synchronizer 228 can be prevented from engaging the latches 222 until all the triggers 224 have been disengaged. Any one trigger 224 can keep the latching synchronizer 228 from moving upward to engage each of the latches 222 with the drogue 150. When all three triggers 224 are disengaged after proper alignment within the drogue 150, the springs 232 cause the latching synchronizer 228 to move upward, engaging the latches 222 with the strike plates 152 of the drogue 150. Once engaged, the triggers 224 and latches 222 are prevented from retracting until reset by a latch reset motor 230.

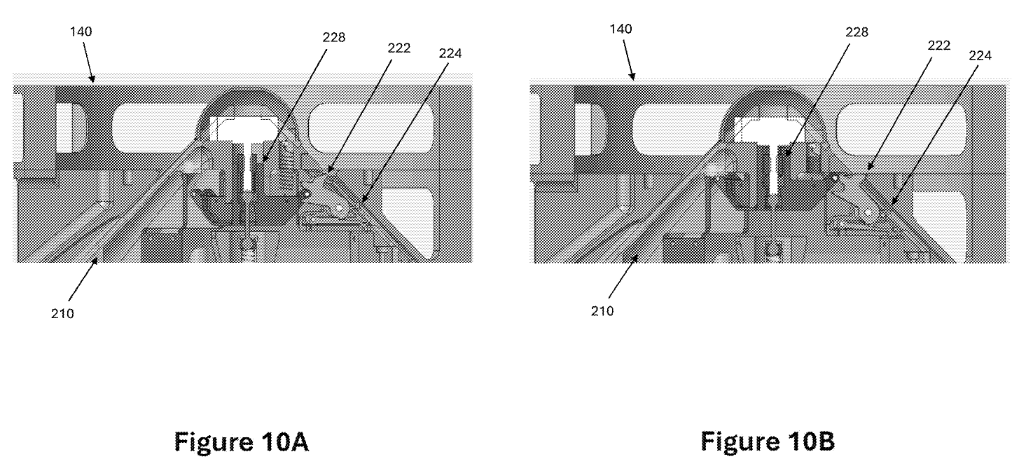

FIGS. 10A and 10B illustrate stages of an example latching process during the soft capture stage. As shown in FIG. 10A, prior to full seating of the probe 210 within the drogue 150, the triggers 224 are armed (e.g., biased by trigger springs 234) and the latches 222 are held in a disengaged/retracted configuration by a latch-trigger interface 236 such that the latching synchronizer 228 is prevented from moving upward. As the probe cover 220 is guided into the drogue 150 and alignment features engage, the probe 210 reaches a seated position in which the triggers 224 contact corresponding engagement features (e.g., striker plates 152) of the drogue 150 and are actuated/disengaged.

FIG. 10B illustrates a configuration after the triggers 224 have been actuated (e.g., all triggers 224 released), in which the latching synchronizer 228 is no longer constrained by the triggers 224 and is biased upward by one or more springs 232. As the latching synchronizer 228 moves upward, it simultaneously drives the plurality of latches 222 from the disengaged configuration toward an engaged configuration with the striker plates 152 of the drogue 150. At which point, the latches 222 are fully engaged with the drogue 150 and the latching synchronizer 228 has moved to a locking position that retains the latches 222 in the engaged configuration (e.g., preventing latch 222 retraction) until a reset operation is performed (e.g., via a latch reset actuator).

### Bearing Assembly

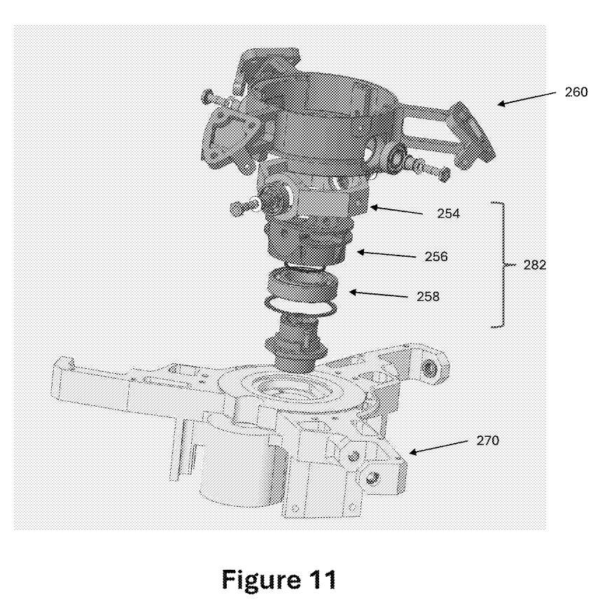

FIG. 11 illustrates an embodiment of a bearing assembly 282, probe housing 270, and probe base 260. The exploded view illustrates mounting of the bearing assembly 282 and the probe housing 270. The bearing assembly can define at least part of an interface between the probe cover 220, probe base 260, and the probe housing 270 by providing a rotational coupling that permits relative rotation while transmitting loads between the probe cover 220 and the probe housing 270. In some embodiments, the bearing assembly 282 is coupled to the probe cover 220 and the probe housing 270 and is configured to rotate such that the probe cover 220 rotates relative to the probe housing 270.

In some embodiments, the bearing assembly 282 comprises a gimbal bearing cage 254, gimbal cage 256, and ball bearing 258. As used herein, a gimbal bearing can comprise a bearing arrangement that includes a gimbal cage (e.g., one or more nested rings and/or a gimbal bearing cage 254) configured to support relative rotation about a plurality of non-parallel axes (e.g., generally orthogonal axes), such that the probe cover 220 can pivot relative to the probe housing 270. For example, the gimbal bearing can be configured to provide two rotational degrees of freedom (e.g., pitch and yaw) and, in some embodiments, can further permit rotation about a third axis (e.g., roll), depending on the configuration and any associated bearing elements.

In an open position (e.g., when a bearing lock assembly 240 is open), the bearing assembly 282 can provide a plurality of rotational degrees of freedom (e.g., two or three rotational degrees of freedom) to facilitate such alignment of the probe cover 220 with the drogue 150 during soft capture and alignment of the probe cover 220 with the probe housing 270 during attenuation. The probe strut assemblies 280 can provide centering bias and additional load paths between the probe cover 220 and the probe housing 270. In a closed position (e.g., when the bearing lock assembly 240 is closed and a bearing lock plug 252 is seated within a bearing lock socket 246), the bearing assembly 282 can be prevented from rotating such that the probe cover 220 is prevented from rotating relative to the probe housing 270.

### Bearing Lock Assembly

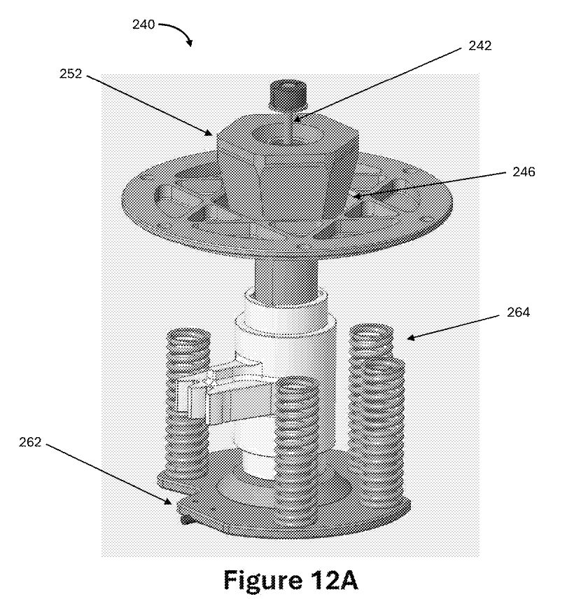

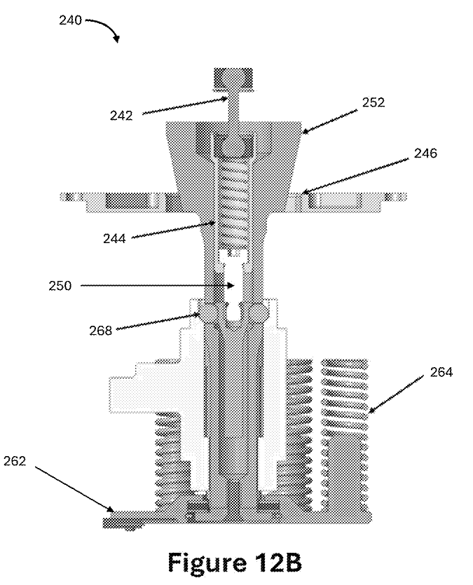

FIGS. 12A and 12B illustrate an embodiment of a bearing lock assembly 240 (also referred to as a DOF lock assembly). FIG. 12A illustrates the bearing lock assembly 240, and FIG. 12B illustrates a cross-section view of the bearing lock assembly 240. The bearing lock assembly 240 is configured to move between an open position and a closed position.

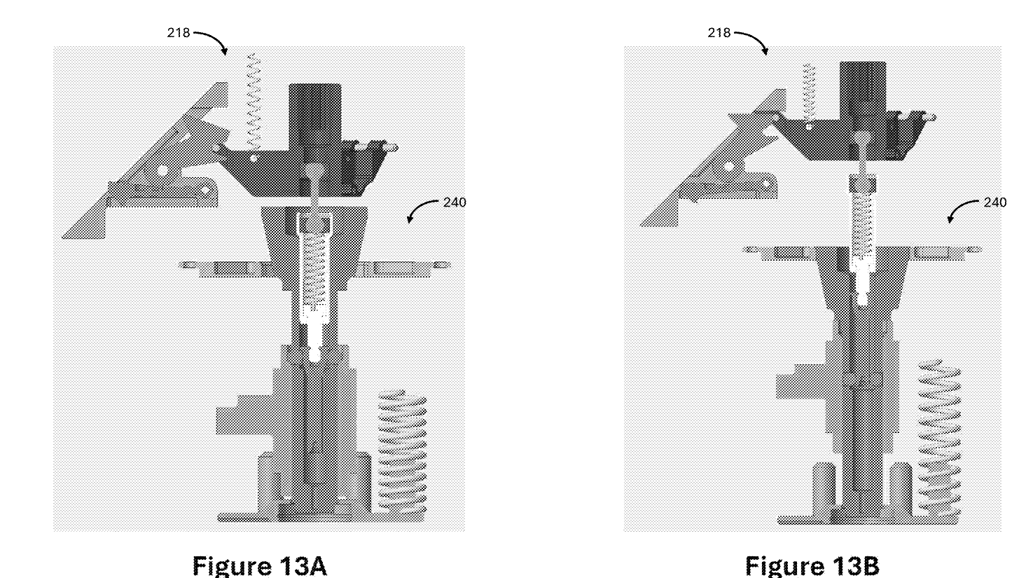

FIG. 13A illustrates the bearing lock assembly 240 in an open position. In the open position, the bearing assembly 282 is configured to rotate such that the probe cover 220 rotates relative to the probe housing 270, and the bearing lock plug 252 is spaced from the bearing lock socket 246 (e.g., defining a gap) such that the bearing lock plug 252 is not seated within the bearing lock socket 246.

FIG. 13B illustrates the bearing lock assembly 240 in a closed position. In the closed position, the bearing lock plug 252 is seated within (e.g., locked within) the bearing lock socket 246 such that the bearing assembly 282 is prevented from rotating and the probe cover 220 is prevented from rotating relative to the probe housing 270 (e.g., the probe 210 is rigidized to a center/null position for attenuation). The bearing lock assembly 240 can be configured to automatically move from the open position to the closed position after the probe 210 is coupled to the drogue 150. The bearing lock assembly 240 can include a bearing lock socket 246, a bearing lock plug 252 (e.g., a tapered plug), one or more force elements (e.g., a plurality of bearing lock springs 264) configured to bias the bearing lock plug 252 toward the bearing lock socket 246, and a release mechanism. In some embodiments, the release mechanism includes a tension link 242 coupled to a latching synchronizer 228. A transfer spring 244 can be coupled between the tension link 242 and a release rod 248, and one or more release members, such as bearing lock release rollers 268 and a release cam 250, can be configured to disengage the bearing lock release rollers 268 to release the bearing lock plug 252.

The latching synchronizer 228 can be configured to engage the probe 210 with the drogue 150 after alignment of the probe cover 220 with the drogue 150. The tension link 242 can be coupled to the latching synchronizer 228 such that, when the latching synchronizer 228 is triggered and engages the latches 222, the latching synchronizer 228 moves upward and pulls the tension link 242. In some embodiments, the upward movement of the tension link 242 is transferred, via a transfer spring 244, to a release rod 248. The release rod 248 can be configured to actuate the release cam 250. Actuation of the release cam 250 can cause the bearing lock release rollers 268 to disengage and move within the bearing lock assembly 240, thereby releasing the bearing lock plug 252. In some embodiments, the bearing lock release rollers 268 constrain the bearing lock assembly 240 (e.g., constrain movement of a bearing lock base plate 262 and/or the bearing lock plug 252) while the bearing lock assembly 240 is in the open position, and disengagement of the bearing lock release rollers 268 permits movement of the bearing lock assembly 240 toward the closed position.

After release of the bearing lock plug 252 (e.g., after disengagement of the bearing lock release rollers 268), the bearing lock springs 264 can apply a downward force on a bearing lock base plate 262. The bearing lock plug 252 is coupled to (e.g., connected to) the bearing lock base plate 262 such that the downward force moves the bearing lock plug 252 toward, and into, the bearing lock socket 246. The movement of the bearing lock plug 252 into the bearing lock socket 246 can prevent movement of the bearing assembly 282 (e.g., prevent rotation of the bearing assembly 282 such that the probe cover 220 is prevented from rotating relative to the probe housing 270). This can change the probe cover-probe housing interface from a compliant, multi-axis rotational interface to a rigidized interface. The bearing lock plug 252 can move into the bearing lock socket 246 over a period of time and seats progressively as oscillatory motion of the probe cover 220 relative to the probe housing 270 decays. During such period of time, the probe cover 220 can continue to move relative to the probe housing 270 (e.g., oscillate about one or more rotational axes permitted by the bearing assembly 282 in the open position) until the bearing lock plug 252 is seated within the bearing lock socket 246.

The plurality of probe strut assemblies 280 that connect the probe cover 220 to the probe housing 270 can provide a compliant restoring bias that tends to return the probe cover 220 toward the center (null) position during such oscillations. For example, as the probe cover 220 rotates and/or shifts relative to the probe housing 270, one or more probe strut assemblies 280 can compress and/or extend such that the associated springs generate restoring forces and moments that oppose the deflection. Because the probe strut assemblies 280 are coupled at spaced-apart locations around the probe cover 220 and the probe housing 270, the probe strut assemblies 280 can react to both forces and moments at the probe cover 220/probe housing 270 interface and can share such loads across the plurality of probe strut assemblies 280.

As the probe cover 220 moves toward the center position, the bearing lock plug 252 can continue to move into the bearing lock socket 246 until the bearing lock plug 252 is fully seated within the bearing lock socket 246 and the bearing lock assembly 240 is in the closed position. In some embodiments, the bearing lock plug 252 includes a tapered outer surface (e.g., a conical or frustoconical profile) and the bearing lock socket 246 includes a corresponding tapered inner surface configured to receive the bearing lock plug 252, such that contact between the tapered surfaces provides a lead-in and guides the bearing lock plug 252 during progressive seating.

The bearing lock assembly 240 can be partially reset when the probe 210 is pulled down during retraction toward hard capture, and can be fully reset after the latches 222 are reset during an undocking process and/or when the probe 210 is returned to a stowed position. In some embodiments, resetting the bearing lock assembly 240 includes repositioning the bearing lock plug 252 relative to the bearing lock socket 246 (e.g., recreating the gap) and re-engaging the bearing lock release rollers 268 with the release cam 250 such that the bearing lock plug 252 is again restrained when the bearing lock assembly 240 is in the open position.

### Probe Legs

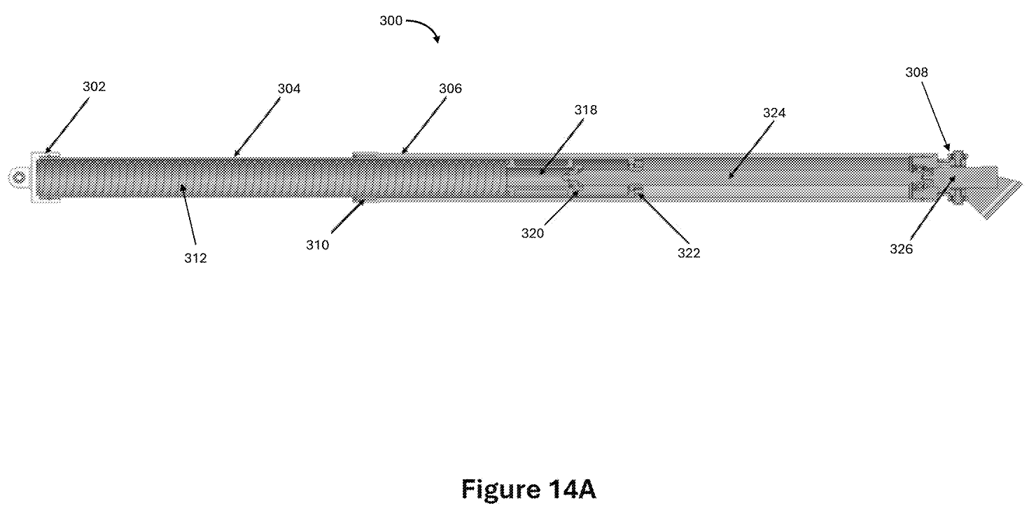

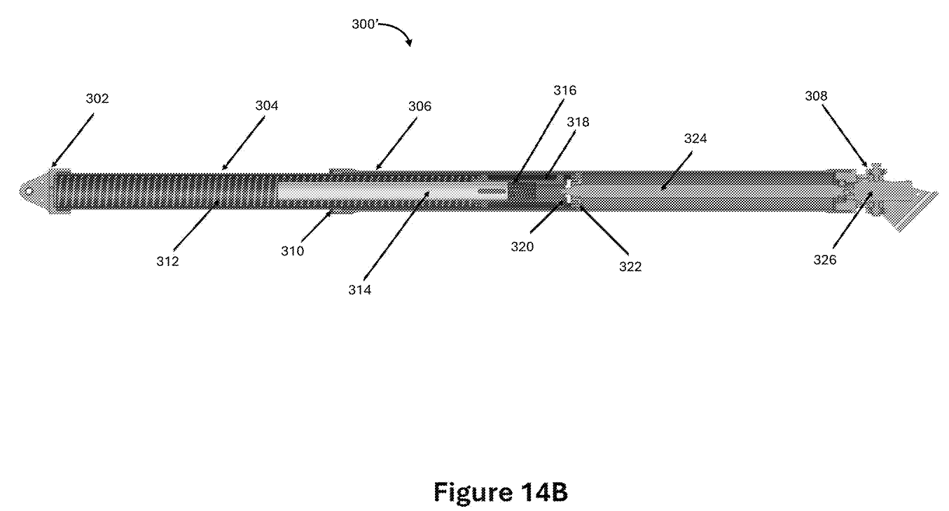

FIGS. 14A and 14B illustrate cross-sections of embodiments of a probe leg 300, 300’. In the illustrated embodiment, the soft capture system includes three probe legs 300 that are coupled between the probe 210 and the chaser vehicle 120. A first end of the probe leg 300 is coupled to a housing arm 272. The probe leg 300 is coupled to the chaser vehicle 120 at the second end. The second end may be coupled to the chaser vehicle 120 via any appropriate means, such as, for example, bolts, rivets, welding, etc.

The probe leg 300 has a telescoping design in which a stanchion 304 is disposed within, and configured to telescope relative to, an outer tube 306, which allows the probe leg 300 to extend and contract during the soft capture system sequence. A strut main spring 312 is positioned within the stanchion 304 and biases the probe leg 300 toward extension. The strut main spring 312 interfaces with a spring follower 318 disposed in the outer tube 306, and the spring follower 318 couples the strut main spring 312 to a lead screw 324 (e.g., via a bushing 322 and a thrust bearing 320). The lead screw 324 back-drives a damper 326, such as a rotary eddy current, coupled toward the second end of the probe leg 300 (e.g., proximate the 2-axis gimbal 308), thereby dissipating energy during telescoping motion. The 2-axis gimbal 308 can provide rotation about two non-parallel axes to accommodate angular misalignment between the probe leg 300 and the target vehicle 110 during attenuation and retraction.

The spring follower 318 can be configured to translate axially within the outer tube 306 in response to compression and decompression of the strut main spring 312 and is configured to interface with a bushing 322 that is threadably engaged with the lead screw 324. In some embodiments, the lead screw 324 is fixed relative to the outer tube 306 such that axial translation of the spring follower 318 causes relative motion at the lead screw, thereby causing the lead nut 326 to rotate. The spring follower 318 can be configured to react to axial loads through a thrust bearing 320 and can be configured to transmit the rotation to the damper 326 to provide damping of the telescoping motion of the probe leg 300.

In the embodiment illustrated in FIG. 14B, the probe leg 300’ further comprises a bottom-out spring 316 and a bottom-out spring extension 314 associated with the spring follower 318. For example, a bottom-out spring extension 314 can be disposed at least partially within the spring follower 318 and can be configured to receive a bottom-out spring 316 such that, when the probe leg 300 is compressed toward a minimum-length storage (stowed) position, the bottom-out spring 316 engages after a predetermined stroke and is compressed. The bottom-out spring 316 is configured to provide an additional spring force, beyond that provided by the strut main spring 312, to bias the probe leg 300 toward extension. In some embodiments, after the probe leg 300 has been compressed into the storage position (e.g., during stow), the bottom-out spring 316 is configured to store energy and to subsequently assist in extending the probe leg 300 toward a maximum extension (e.g., a ready-to-capture position) when constraints on the probe leg 300 are released. The bottom-out spring extension 314 can be configured to guide and retain the bottom-out spring 316 and to transfer load between the bottom-out spring 316 and one or more of the spring follower 318, the stanchion 304, and/or the outer tube 306.

The probe legs 300 are a key part of the soft capture system and provide several functions, including at least: providing range of motion to the probe and providing spring force to extend the probe prior to soft capture, energy attenuation, and misalignment attenuation.

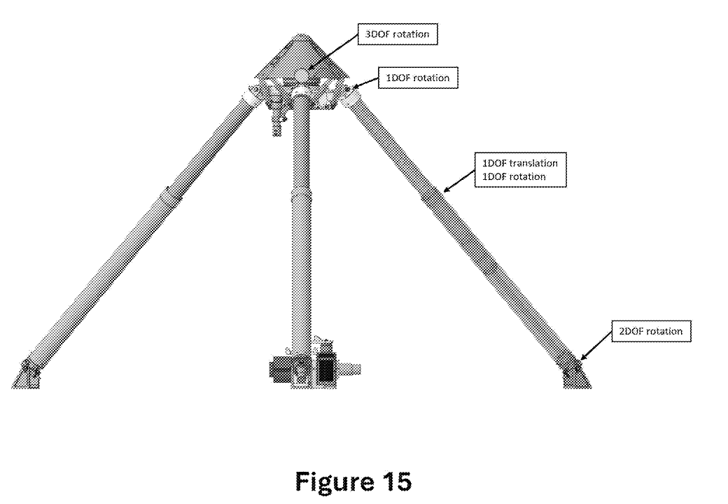

FIG. 15 illustrates the degrees of freedom that are provided by the leg and probe subassemblies during operation. The bearing assembly 282 is positioned within the probe cover and can provide up to three rotational degrees of freedom. In some embodiments, the probe leg provides a defined set of degrees of freedom through its joint and telescoping interfaces. For example, the clevis joint at the first end of the probe leg is configured to provide one degree of rotational freedom. The stanchion and the outer tube are configured as a telescoping interface that provides one degree of translational freedom along a leg axis and one degree of rotational freedom about the leg axis. The gimbal joint at the second end of the probe leg is configured to provide two degrees of rotational freedom relative to the target vehicle (e.g., relative to a fixed structure). The probe and tripod configuration can provide 6-DOF motion, the tripod and probe have specific joint configuration that can provide the probe with six degrees of freedom, although some motions are coupled with others.

### Cable Retract Mechanism

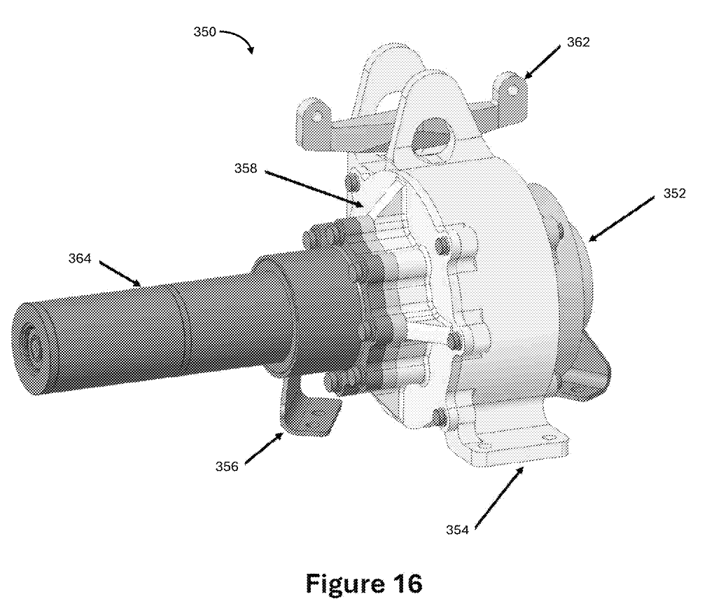

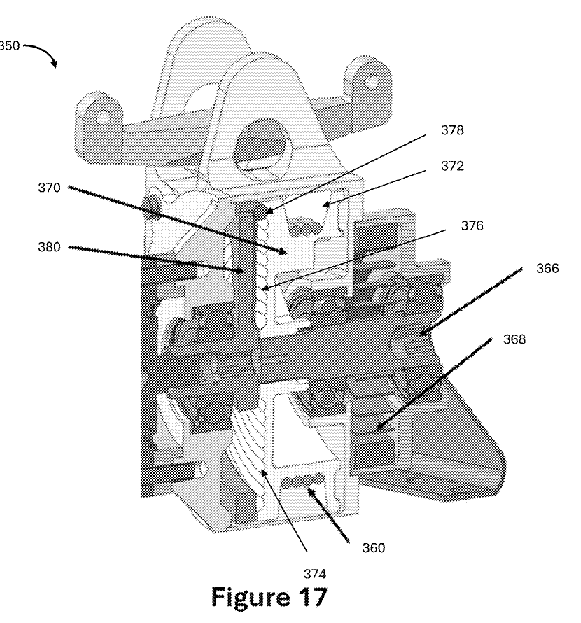

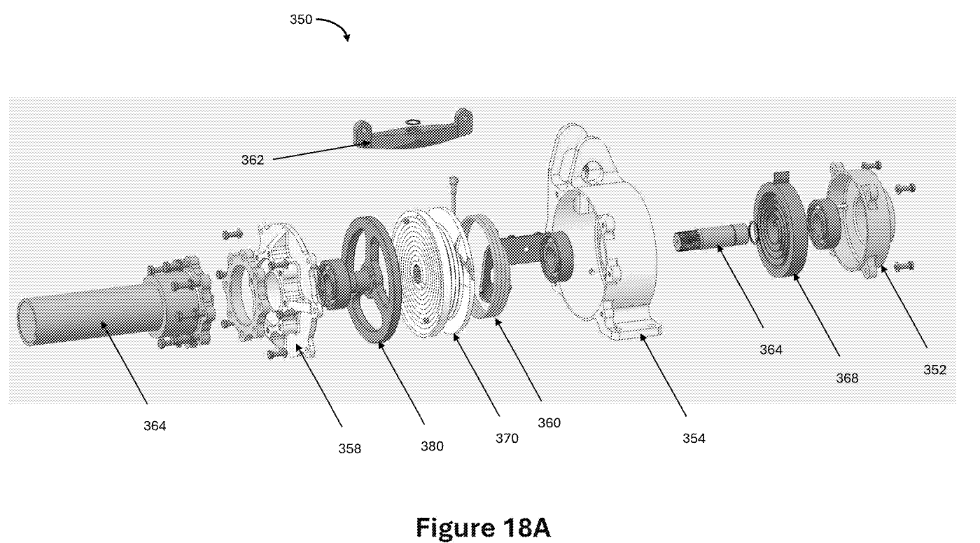

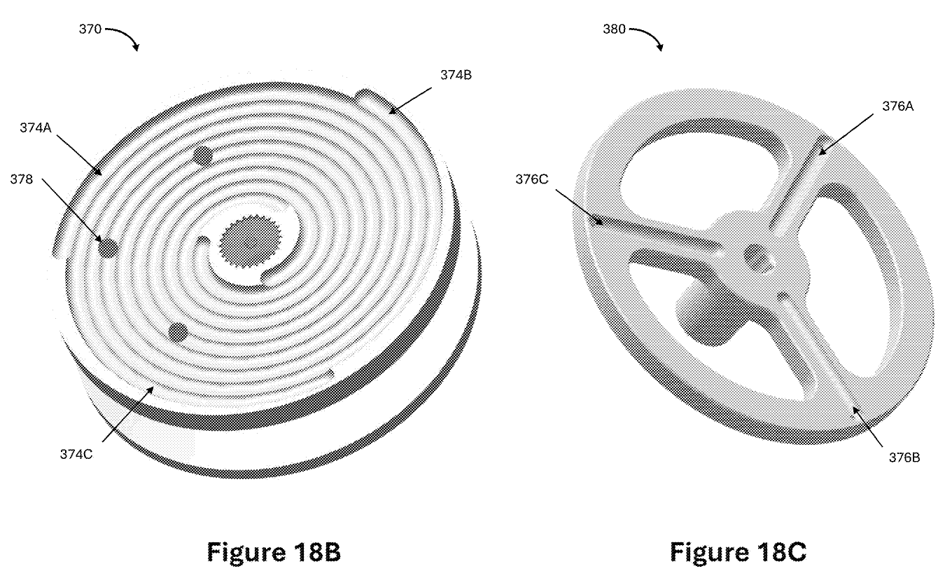

FIG. 16 illustrates an embodiment of the cable retract mechanism 350. FIG. 17 illustrates a cross-section view of the cable retract mechanism 350. FIG. 18A illustrates an exploded view of the cable retract mechanism 350. FIG. 18B illustrates an example embodiment of a spool 370, including a plurality of spiral grooves 374 and bearings 374. FIG. 18C illustrates an example embodiment of a slotted shaft 380, including a plurality of slot grooves 376.

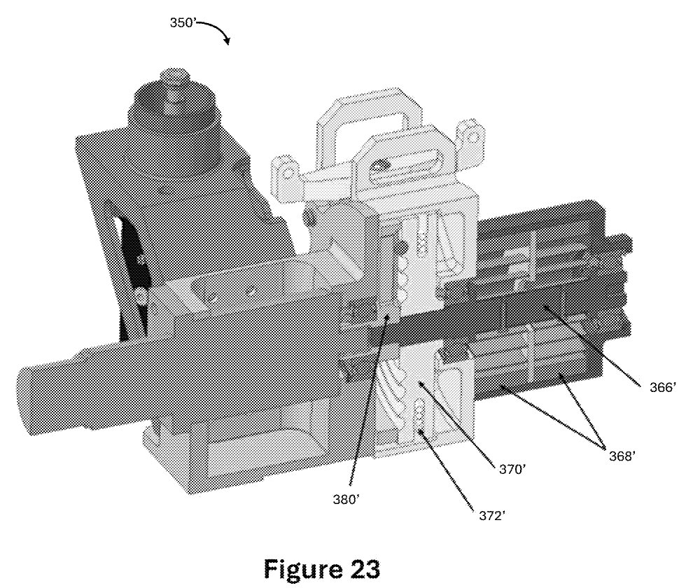

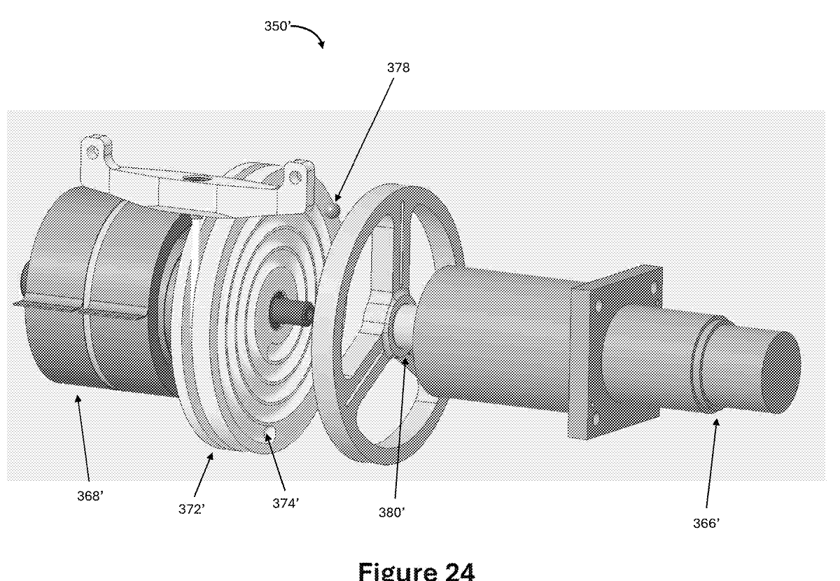

The cable retract mechanism 350 is configured to extend and retract the probe 210 during the docking process using a cable 360. The cable 360 is coupled to the yoke 362, the yoke 362 is coupled to the probe assembly 210, and the cable retract mechanism 350 is configured to retract the yoke 362 and cable 360 within the retraction mechanism housing 354 of the cable retract mechanism 350. The cable retract mechanism 350 includes at least one spring (e.g., one or more power springs 368) configured to apply a substantially constant tension force to the cable 360 (e.g., via an arbor 366 and/or spool 370) to retract the cable 360 and pull slack out of the cable 360 during the attenuation stage. This can reduce unmanaged slack in the cable 360. In some embodiments, the spring tension in the cable 360, in combination with the configuration of the probe leg 300 springs, can determine the ready-to-capture (RTC) height of the probe 210. In some embodiments, the spool 370 includes a cable slot 372 configured to receive the cable 360 when the cable 360 is retracted. In one embodiment, the cable slot 372 comprises a continuous groove configured to accommodate the length of the cable 360 when the cable 360 is fully retracted, such that successive revolutions of the cable 360 within the cable slot 372 are positioned adjacently within the continuous groove. In another embodiment (illustrated in FIGS. 23 and 24), the cable slot 372’ is configured such that revolutions of the cable 360 within the cable slot 372’ overlap vertically within the cable slot 372’ (e.g., a multi-layer winding arrangement).

The cable retract mechanism 350 includes a securing bracket 290, an actuator 364, a yoke 362 coupled to a cable 360, an actuator housing 358, a retraction mechanism housing 354, and a power spring housing 352. The cable retract mechanism 350 includes a housing that supports an arbor 366 and a spool 370 coupled to the arbor 366. The spool 370 includes a cable slot 372 configured to receive at least a portion of the cable 360 (e.g., to stow the cable 360 when fully retracted) and at least one spiral groove 374 (e.g., a first spiral groove 374A) extending between a first end at a center portion of the spool 370 and a second end at an outer portion of the spool 370. The cable retract mechanism 350 can further include a slotted shaft 380, and the actuator 364 can be coupled to the slotted shaft 380 and configured to rotate the slotted shaft 380. The slotted shaft 380 can include at least shaft groove 376 that extends radially on the slotted shaft 380 from an inner portion (e.g., proximate a center axis) toward an outer portion (e.g., toward an outer edge) of the slotted shaft 380. At least a first ball bearing 378 can be positioned between the first spiral groove 374 of the spool 370 and the first shaft groove of the slotted shaft 380 such that the first bearing is configured to move within the first spiral groove 374 and within the first shaft groove 376. In operation, as the bearing travels along the spiral groove 374, the bearing is also guided by, and moves radially within, the shaft groove 376, such that relative rotation between the spool 370 and the slotted shaft 380 can be accommodated while the bearing 378 remains captured at the spiral groove/shaft groove interface.

The actuator 364 can be coupled to the spool 370 via one or more ball bearings 378 traveling through one or more spiral grooves 374 in the spool 370 and within one or more corresponding shaft grooves 376 of the slotted shaft 380. In some embodiments, the spool 370 is configured to rotate relative to the slotted shaft 380 when a bearing is positioned between the first end and the second end of a corresponding spiral groove, such that rotation of the slotted shaft 380 does not rotate the spool 370 over a range of travel (sometimes referred to as a deadband zone). This can allow the cable 360 to extend and retract passively for a portion of the cable 360 length while the actuator 364 remains disengaged. In some embodiments, the slotted shaft 380 includes a plurality of radial shaft grooves 376, each radial shaft groove extending from an inner portion of the slotted shaft 380 toward an outer portion of the slotted shaft 380 and configured to accommodate a corresponding bearing 378. The illustrated spool 370 includes a plurality of non-overlapping spiral grooves 374 (e.g., first spiral groove 374A, second spiral groove 374B, and third spiral groove 374C), and each spiral groove 374 can interface with a corresponding radial shaft groove 376 (e.g., first shaft groove 376A, second shaft groove 376B, and third shaft groove 376C) via a corresponding bearing positioned therebetween. In such embodiments, as each bearing moves within its corresponding spiral groove 374, that bearing 378 also moves radially within its corresponding radial shaft groove. When a bearing is positioned at the first end or the second end of its corresponding spiral groove 374 (e.g., at an end stop), rotation of the slotted shaft 380 can transfer torque to the spool 370 through the bearing(s) 378 such that the spool 370 is actively driven to extend and/or retract the cable 360. In some embodiments, using a plurality of bearings distributed circumferentially about the slotted shaft 380 can distribute the load (e.g., actuator-applied torque and associated contact forces) transferred by the actuator 364 to the spool 370 via the slotted shaft 380 when the bearings 378 reach the end stop(s), which can reduce localized stresses at any one bearing/groove interface.

When at the RTC position in the preparation stage, the actuator 364 can be decoupled from the spool 370 in an extend direction via the spiral groove/bearing interface such that the spool 370 is permitted to rotate relative to the slotted shaft 380 while the bearing is between the first end and the second end of the spiral groove 374 (i.e., within the deadband). This allows the one or more springs (e.g., power springs 368) to rewind the spool 370 as required to maintain cable 360 tension and manage slack without requiring the actuator 364 to turn on. With this arrangement, the actuator 364 can be used primarily to extend and retract the cable 360 when the bearing is positioned at an end stop and the actuator 364 is engaged with the spool 370, while the one or more springs (e.g., power springs 368) passively manage cable 360 slack during the attenuation stage. After the attenuation stage is complete (e.g., when an attenuation threshold is satisfied), the cable retract mechanism 350 can be configured to actively engage the actuator 364 and retract the probe 210 during the retraction stage.

### Alternative Embodiments

### Probe Assembly

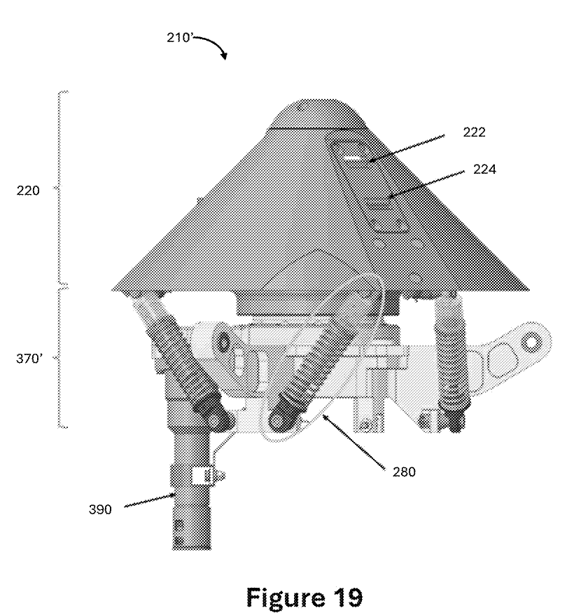

FIG. 19 illustrates another embodiment of the probe assembly 210’ of the soft capture system. In this alternative embodiment, the probe assembly 210’ includes a probe cover 220, a probe housing 270’, a bearing assembly 282’, and a bearing lock assembly 240, and can further include a roll control geartrain 390 as described herein. In some embodiments, the probe housing 270’ includes a plurality of housing arms that are configured such that an axis of each probe leg 300 is aligned (or approximately aligned) with a center axis of the probe assembly 210’. For example, the probe legs 300 can be coupled to respective housing arms such that the legs extend generally parallel to, or colinear with, the center axis of the probe assembly rather than being coupled at an offset angle. Such an arrangement can reduce lateral components of retraction loads transmitted through the legs and can provide a more axial load path between the cable retract mechanism, the probe housing 270’, and the probe legs 300.

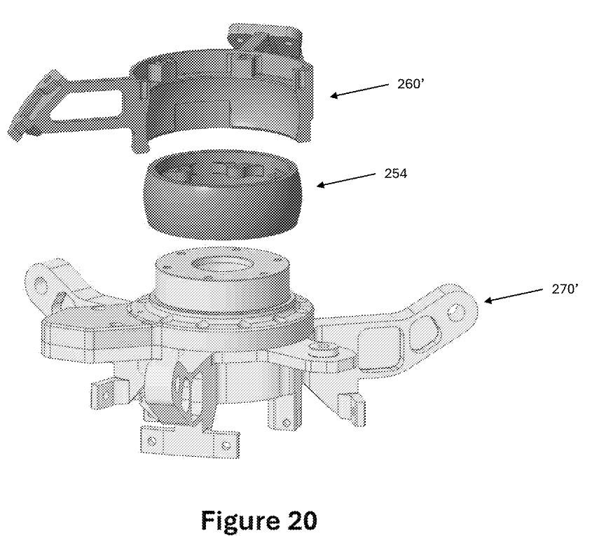

FIG. 20 illustrates an exploded view of bearing assembly 282’. The bearing assembly 282’ comprises a 3-axis bearing (e.g., a three rotational degree of freedom bearing) configured to allow relative rotation between the probe cover 220 and the probe housing 270’ about pitch, yaw, and roll axes while the bearing lock assembly 240 is in an open position. In some embodiments, when the bearing lock assembly 240 transitions to a closed position, the bearing lock assembly 240 constrains relative rotation between the probe cover 220 and the probe housing 270’ about at least pitch and yaw axes. In some embodiments, when the bearing lock assembly 240 is in the closed position, the bearing lock assembly 240 also constrains relative rotation about a roll axis (e.g., fully rigidizes the probe cover relative to the probe housing). In some embodiments, when the bearing lock assembly 240 is in the closed position, relative rotation about the roll axis is permitted while pitch and yaw are constrained.

### Roll Control Geartrain Assembly

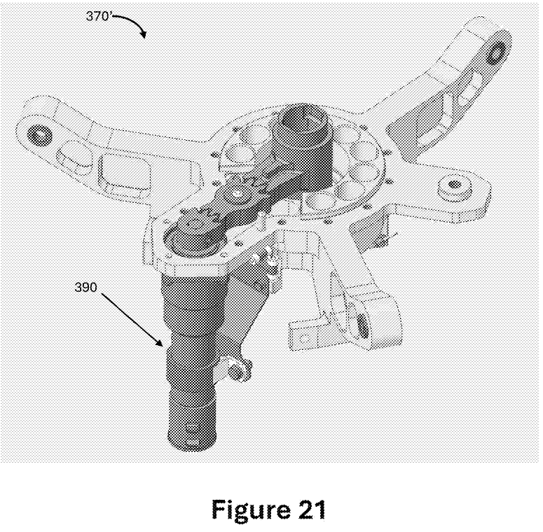

FIG. 21 illustrates an embodiment of a roll control geartrain 390. The roll control geartrain 390 can be configured to mechanically couple a roll axis of the probe assembly 210’ to a roll control element (e.g., a rotary eddy current damper and/or an actuator) such that roll motion of the probe cover relative to the probe housing can be damped and/or controlled. In the illustrated embodiment, the roll control geartrain 390 is configured to control roll after the bearing lock assembly 240 is closed. For example, in embodiments in which the bearing lock assembly 240, when closed, constrains pitch and yaw while permitting relative rotation about the roll axis, the roll control geartrain 390 can remain operable to transmit roll motion through a geartrain path to the rotary damper and/or a roll actuator. In some embodiments, the geartrain 390 can provide a gear ratio configured to increase an effective damping rate and/or control authority at the roll axis. Accordingly, roll oscillations that remain after pitch and yaw are constrained can be attenuated and/or a desired roll alignment can be maintained. In some embodiments, the bearing lock assembly 240, when closed, constrains pitch, yaw, and roll (e.g., fully rigidizes the probe cover relative to the probe housing), and the roll control geartrain 390 can be configured to control and/or damp roll prior to closure and/or during other phases of operation in which roll motion is available.

### Cable Retract Mechanism

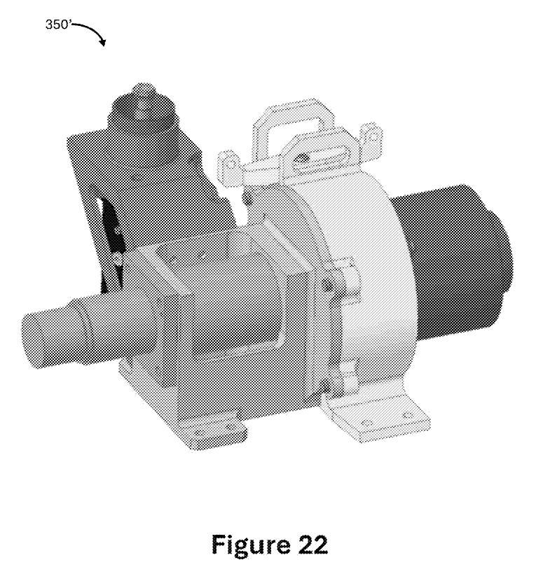

FIG. 22 illustrates another embodiment of the cable retract mechanism 350’ of the soft capture system. FIG. 23 illustrates a cross-section view of the cable retract mechanism 350’ of FIG. 22. FIG. 24 illustrates a partial exploded view of the cable retract mechanism 350’ of FIG. 22. The cable retract mechanism 350’ includes a spool 370’ having a single spiral groove 374’ configured to interface with a groove of a slotted shaft 380’ via a bearing 378 (e.g., a ball) to selectively engage an actuator 366’ with the spool 370’, as described herein. In some embodiments, the single spiral groove 374’ is configured to accommodate a plurality of bearings 378 (e.g., two or more bearings) positioned within the single spiral groove 374’. For example, the plurality of bearings can be circumferentially spaced about the slotted shaft 380’ and can each interface with the groove of the slotted shaft, such that when the bearings reach an end stop, the plurality of bearings distribute load (e.g., actuator-applied torque and associated contact forces) transferred from the actuator to the spool via the slotted shaft. In some embodiments, the spool 370’ further includes a cable slot 372’ configured such that revolutions of the cable overlap vertically within the cable slot when the cable is retracted (e.g., a multi-layer winding arrangement), such that a length of cable can be stowed within a reduced axial width of the spool. The single spiral groove 374’ can provide a deadband in which the spool 370’ is permitted to rotate relative to the slotted shaft 380’ while the bearing is between end stops. The bearing can transfer torque between the slotted shaft and the spool when the bearing is at an end stop.

### Examples of Attenuation Stage and Retraction Stage Probe movement

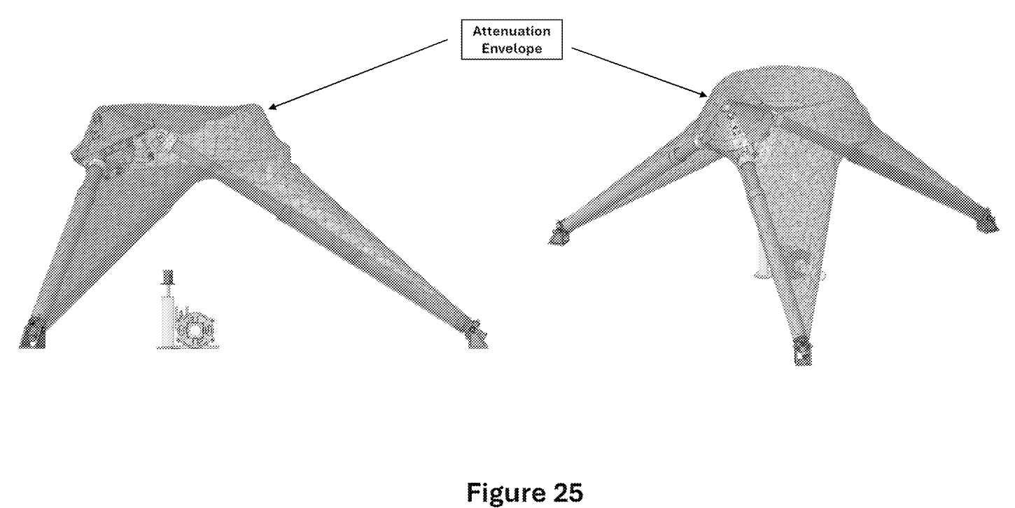

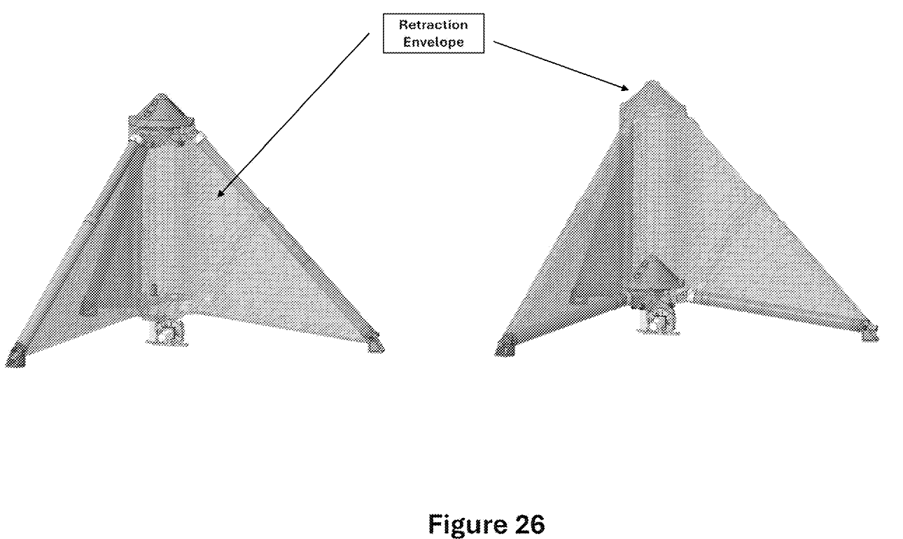

FIGS. 25-26 provide additional schematic representations and data associated with the movement of the probe during the attenuation stage and retraction stage of the docking process.

FIG. 25 illustrates a schematic representation of an attenuation envelope of the soft capture system. The attenuation envelope generally represents motion of the probe and struts during the attenuation stage. The figures illustrate the probe in different positions. Though not illustrated, the probe would be connected to the drogue of the chaser vehicle during the attenuation process.

FIG. 26 illustrates an example embodiment of a retraction envelope. The retraction envelope generally represents motion of the probe and struts during the retraction stage. In the figure on the left, the probe is positioned at the max height with the compression spring of the struts fully extended in the RTC position or after attenuation is complete. In the figure on the right, the probe is illustrated in the fully retracted position with the struts at their minimum length.

### Additional Considerations

Various modifications to the implementations described in this disclosure will be readily apparent to those skilled in the art, and the generic principles defined herein may be applied to other implementations without departing from the spirit or scope of this disclosure. Thus, the disclosure is not intended to be limited to the implementations shown herein but is to be accorded with the widest scope consistent with the claims, the principles, and the novel features disclosed herein. The word “example” is used exclusively herein to mean “serving as an example, instance, or illustration.” Any implementation described herein as “example” is not necessarily to be construed as preferred or advantageous over other implementations, unless otherwise stated.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Additionally, other implementations are within the scope of the following claims. In some cases, the actions recited in the claims may be performed in a different order and still achieve desirable results.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed:

1. A soft capture docking system for a target spacecraft vehicle, the soft capture docking system comprising:
a probe assembly configured to couple with a drogue assembly of a chaser spacecraft vehicle;
a plurality of struts coupled to the probe assembly and the target spacecraft vehicle, the plurality of struts configured to attenuate motion between the target spacecraft vehicle and the chaser spacecraft vehicle; and
a cable retract mechanism comprising a cable coupled to the probe assembly, wherein the cable retract mechanism is configured to retract the probe assembly, wherein the cable retract mechanism is configured to create a deadband zone such that there is constant tension on the cable during attenuation.

2. The soft capture docking system of claim 1, the cable retract mechanism further comprising:
a housing comprising:
an arbor,
a spool coupled to the arbor, the spool including a cable slot and at least one spiral groove including a first spiral groove extending between a first end at a center portion of the spool and a second end at an outer portion of the spool, wherein at least a portion of the cable is positioned within the cable slot,
a slotted shaft including at least a first groove;
an actuator coupled to the slotted shaft and configured to rotate the slotted shaft; and
at least a first bearing positioned between the first spiral groove and the first groove, wherein the first bearing is configured to move within the first spiral groove and the first groove.

3. The soft capture docking system of claim 2, wherein the first groove of the slotted shaft extends radially outward from an inner portion of the slotted shaft to an outer portion of the slotted shaft.

4. The soft capture docking system of claim 2, wherein the cable is coupled to a yoke, wherein the yoke is coupled to the probe assembly, wherein the cable retract mechanism is configured to retract the yoke and the cable within the housing of the cable retract mechanism.

5. The soft capture docking system of claim 2, wherein the cable slot comprises a continuous groove configured to accommodate a length of the cable when the cable is fully retracted, such that revolutions of the cable within the cable slot are positioned adjacently within the continuous groove.

6. The soft capture docking system of claim 2, wherein the cable slot is configured such that revolutions of the cable within the cable slot overlap vertically within the cable slot.

7. The soft capture docking system of claim 2 further comprising at least one spring configured to apply a constant tension force on the arbor to retract the cable.

8. The soft capture docking system of claim 2, wherein the spool is configured to rotate relative to the slotted shaft when the first bearing is positioned between the first end and the second end of the first spiral groove.

9. The soft capture docking system of claim 2, wherein rotation of the slotted shaft does not rotate the spool when the first bearing is positioned between the first end and the second end of the first spiral groove.

10. The soft capture docking system of claim 2, wherein, when the first bearing is positioned at the first end or the second end of the first spiral groove, rotation of the slotted shaft rotates the spool.

11. The soft capture docking system of claim 2 further comprising a second spiral groove and a third spiral groove, wherein each of the first spiral groove, the second spiral groove, and the third spiral groove are the same length and non-overlapping.

12. The soft capture docking system of claim 11 further comprising a second bearing positioned within the second spiral groove and a third bearing positioned within the third spiral groove, wherein the slotted shaft comprises a second groove configured to interface with the second bearing, and a third groove configured to interface with the third bearing.

13. The soft capture docking system of claim 12, wherein the first bearing, the second bearing, and the third bearing are configured such that each bearing is in the same relative position within their corresponding spiral groove during rotation of the spool.

14. A cable retract mechanism for a spacecraft vehicle, the cable retract mechanism comprising:
a housing comprising:
an arbor,
a spool coupled to the arbor, the spool including a cable slot and at least one spiral groove including a first spiral groove extending between a first end at a center portion of the spool and a second end at an outer portion of the spool, wherein at least a portion of a cable is positioned within the cable slot,
a slotted shaft including at least a first groove;
an actuator coupled to the slotted shaft and configured to rotate the slotted shaft;
at least a first bearing positioned between the first spiral groove and the first groove, wherein the first bearing is configured to move within the first spiral groove and the first groove; and
a yoke coupled to the cable, wherein the yoke is configured to be coupled to a probe assembly of the spacecraft vehicle.

15. The cable retract mechanism of claim 14, wherein the first groove of the slotted shaft extends radially outward from an inner portion of the slotted shaft to an outer portion of the slotted shaft.

16. The cable retract mechanism of claim 14, wherein the cable is coupled to a yoke, wherein the yoke is coupled to the probe assembly, wherein the cable retract mechanism is configured to retract the yoke and cable within the housing of the cable retract mechanism.

17. The cable retract mechanism of claim 14, wherein the cable slot comprises a continuous groove configured to accommodate a length of the cable when the cable is fully retracted, such that revolutions of the cable within the cable slot are positioned adjacently within the continuous groove.

18. The cable retract mechanism of claim 14, wherein the cable slot is configured such that revolutions of the cable within the cable slot overlap vertically within the cable slot.

19. The cable retract mechanism of claim 14 further comprising at least one spring configured to apply a constant tension force on the arbor to retract the cable.

20. The cable retract mechanism of claim 14, wherein the spool is configured to rotate relative to the slotted shaft when the first bearing is positioned between the first end and the second end of the first spiral groove.
